(19) United States
(12) Patent Application Publication
(10) Pub. No.: US 2005/0128867 A1
(43) Pub. Date: Jun. 16, 2005

(54) Bone cement mixing and delivery system

(76) Inventors: Bruce D. Henniges, Galesburg, MI (US); Christopher M. Tague, Delton, MI (US); Jared P. Coffeen, Paw Paw, MI (US); Richard F. Huyser, Kalamazoo, MI (US); Marshall K. Proulx, Kalamazoo, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/991,894

(22) Filed: Nov. 18, 2004

Related U.S. Application Data
(63) Continuation-in-part of application No. 10/843,813, filed on May 12, 2004.
(60) Provisional application No. 60/469,651, filed on May 12, 2003.
(60) Provisional application No. 60/520,877, filed on Nov. 18, 2003.

(51) Int. Cl. B01F 13/06

(52) U.S. Cl. 366/139; 366/189

(57) ABSTRACT

A bone cement mixing and delivery system is provided. The system includes a mixing cartridge for receiving liquid and powder components of bone cement, a mixing device for mixing the components, and a delivery gun for discharging the bone cement from the mixing cartridge. A bone cement loading system is provided to load the components in the mixing cartridge, while a rotary power tool or a mixing handle can be selectively, interchangeably, and operatively connected to the mixing device to mix the components once loaded. A converter can also be used to convert rotational input from the rotary power tool into rotational and axial output to simplify mixing of the components. After mixing, the cartridge is placed in the delivery gun. The delivery gun comprises a drive rod having a plurality of teeth. At least one pawl member engages the teeth the advance the drive rod and discharge the bone cement from the cartridge.

### RELATED APPLICATIONS

This application is a continuation-in-part of U.S. patent application Ser. No. 10/843,813, filed May 12, 2004, which claims the benefit of U.S. provisional patent application Ser. No. 60/469,651, filed May 12, 2003 and U.S. provisional patent application Ser. No. 60/520,877, filed Nov. 18, 2003, the advantages and disclosures of which are herein incorporated by reference.

### FIELD OF THE INVENTION

The present invention generally relates to a bone cement mixing and delivery system. More specifically, the present invention relates to a mixing cartridge for receiving liquid and powder components of bone cement to be mixed, a mixing device for mixing the components, and a delivery gun for discharging the bone cement from the mixing cartridge into an anatomical site of a patient.

### BACKGROUND OF THE INVENTION

Bone cement mixing and delivery systems are well known for receiving and mixing liquid and powder components of bone cement and delivering the prepared bone cement to an anatomical site during various surgical procedures. Bone cement is particularly useful in orthopedic procedures in which a prosthetic device is fixed to a bone or joint structure to improve the strength, rigidity, and movement of the structure. In a total hip arthroplasty (THA) procedure, in which a hip joint is replaced with a prosthetic device, bone cement is used to fix the prosthetic device in place in a medullary canal of a femur.

Typically, the bone cement is prepared in a mixing cartridge. The mixing cartridge includes a cylinder having proximal and distal ends with a mixing chamber defined between the ends. The mixing cartridge further includes a cap to cover the proximal end of the cylinder and a piston disposed in the distal end of the cylinder such that the mixing chamber is further defined between the cap and the piston. The piston may be releasably secured in a locked position in the cylinder by a cotter pin. The cap supports a mixing device, i.e., a mixing shaft and blade, for mixing the liquid and powder components of the bone cement in the mixing chamber. Typically, a manual mixing handle is connected to the mixing shaft to mix the components of the bone cement.

Once the bone cement is mixed, the mixing cartridge is prepared for inserting into a delivery gun to discharge the bone cement. This may include disengaging the mixing shaft and coupling a nozzle to the cap to provide a discharge point for the bone cement. At the same time, the piston is released from the locked position in the distal end of the cylinder by pulling the cotter pin. This allows the piston to be driven by the delivery gun through the mixing chamber to discharge the bone cement from the nozzle.

Once the piston is released from the locked position, the mixing cartridge is inserted into the delivery gun. A typical delivery gun includes a ram disk that engages the piston and drives the piston through the mixing chamber to discharge the bone cement from the nozzle. The delivery gun includes a cradle for supporting the mixing cartridge and a casing for supporting a drive rod that engages the ram disk and advances the ram disk to drive the piston. The drive rod includes a plurality of teeth and a pawl member engages the teeth to advance the drive rod. A trigger supports the pawl member and the casing rotatably supports the trigger. Actuation of the trigger relative to the casing urges the pawl member against the teeth to advance the drive rod and discharge the bone cement into the anatomical site.

### BRIEF SUMMARY OF THE INVENTION

A bone cement loading system for receiving liquid and powder components of bone cement to be mixed for medical use is provided. The bone cement loading system includes a cylinder having an open proximal end and a closed distal end with a mixing chamber defined between the ends. A base is releasably coupled to the closed distal end of the cylinder to support the cylinder while loading the liquid and powder components in the mixing chamber. A funnel is releasably coupled to the open proximal end of the cylinder to channel the components of the bone cement into the mixing chamber. Packaging is used to enclose the cylinder, base, and funnel in a ready-to-use state such that the cylinder, base, and funnel can be transported in the ready-to-use state. A method of loading the components of the bone cement in the bone cement loading system is also provided.

One advantage of the bone cement loading system and method is the ability to provide end users with a pre-assembled, ready-to-use bone cement loading assembly thereby eliminating the need for the user to assemble the base and funnel to the cylinder prior to loading the components in the mixing chamber.

A bone cement mixing system for mixing the liquid and powder components of the bone cement after they are loaded in the mixing chamber is also provided. The bone cement mixing system comprises a cartridge having proximal and distal ends with the mixing chamber defined between the ends. A mixing device is supported by the cartridge to mix the liquid and powder components of the bone cement. A plurality of actuators are capable of being selectively, interchangeably, and operatively connected to the mixing device to actuate the mixing device and mix the liquid and powder components of the bone cement in the mixing chamber. Thus, the bone cement mixing system provides the advantage to the user of selecting the actuator that best meets their particular needs. In one aspect of the bone cement mixing system, the plurality of actuators include a power tool and a manual mixing handle thereby allowing the user to select between power mixing and manual, hand mixing.

In another aspect of the bone cement mixing system, a proximal end of the mixing device is adapted for operatively connecting with each of the plurality of actuators to selectively, interchangeably, and operatively connect each of the plurality of actuators to the mixing device.

In yet another aspect of the bone cement mixing system, an adapter that is separable from and independent of the power tool is used to operatively connect the power tool to the mixing device.

A bone cement mixing system that converts rotational input from a power tool into axial and rotational output is also provided. Here, a converter operatively interconnects the power tool and the mixing device. During use, the converter converts rotational input from the power tool into axial and rotational output. The converter applies the axial and rotational output to the mixing device to completely mix the liquid and powder components of the bone cement in the mixing chamber. A method of mixing the liquid and powder components of the bone cement using the converter is also provided. This configuration allows the user to simply pull a trigger of the power tool to completely mix the components of the bone cement, without having to manually extend and retract the mixing device in the cartridge.

A delivery gun for receiving the cartridge containing the bone cement and delivering the bone cement to an anatomical site is also provided. The delivery gun comprises a casing. A drive rod is supported by the casing and includes a plurality of teeth along a length thereof. At least one pawl member engages the plurality of teeth to advance the drive rod. A trigger is pivotally supported by the casing and operatively connected to the at least one pawl member to advance the drive rod during actuation of the trigger. During actuation of the trigger the at least one pawl member exerts a force upon the drive rod having a force vector with an X component that is from 1 to 6 times larger than a Y component of the force vector.

In one aspect of the delivery gun, the X component of the force vector is parallel to the drive rod and the Y component is transverse to the drive rod. By applying a force having a substantially larger X component than Y component, transverse forces acting on the drive rod are reduced. This is important in reducing wear and other stresses associated with bushings through which the drive rod slides.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is an exploded perspective view of a mixing cartridge of the present invention in combination with a mixing shaft and blade;

FIG. 2 is an assembled perspective view of the mixing cartridge with the mixing shaft and blade supported therein;

FIG. 3 is an exploded perspective view of a cap of the mixing cartridge;

FIG. 4 is a cross-sectional view of the cap of FIG. 3 and a partial cross-sectional view of a cylinder of the mixing cartridge to illustrate fitting of the cap to the cylinder;

FIG. 5 is an exploded perspective view of the cap and the mixing shaft and blade;

FIG. 6 is an assembled perspective view of the cap with the mixing shaft and blade supported therein;

FIG. 7 is a perspective view of the blade;

FIG. 7A is a side elevational view of the blade of FIG. 7;

FIGS. 8-8A and 9 are perspective views of alternative blades;

FIG. 10 is a an exploded perspective view of the mixing shaft and a latch rod;

FIG. 11 is an elevational end view of the mixing shaft and latch rod of FIG. 10;

FIG. 12 is a cross-sectional view of the mixing shaft and latch rod of Figs. 10 and 11;

FIG. 13 is an exploded perspective view of a release latch coupling the mixing shaft and latch rod;

FIGS. 14A-14C illustrate the release of the blade from the mixing shaft;

FIG. 15 is an exploded perspective view of a piston of the mixing cartridge;

FIG. 16 is a cross-sectional view of the piston of FIG. 15;

FIG. 17 is a perspective view of an alternative piston of the mixing cartridge;

FIG. 18 is a top view of the alternative piston of FIG. 17;

FIG. 19 is an exploded perspective view of the cap and a nozzle;

FIG. 20 is an assembled perspective view of the cap and nozzle;

FIG. 21 is a blown-up view of a locking mechanism of the cap and nozzle;

FIGS. 22-23 are perspective views of the nozzle;

FIG. 24 is a perspective view of a delivery gun of the present invention illustrating a linkage system of the delivery gun;

FIGS. 24A-24B illustrate alternative linkage systems of the present invention;

FIG. 25 is an elevational view illustrating release of a locking member securing the piston;

FIG. 26 is a partial perspective view of an alternative linkage system and drive mechanism of the delivery gun;

FIG. 27 is a partial perspective view of the alternative linkage system and drive mechanism of FIG. 26 employing a striker to prevent freeze-up of the drive mechanism;

FIG. 28 is an elevational view of a second alternative embodiment of the linkage system and drive mechanism of the delivery gun in a low-speed position;

FIG. 28A is a blown-up view of the linkage system and drive mechanism of the delivery gun shown in FIG. 28;

FIG. 29 is a perspective view of the second alternative embodiment of the linkage system and drive mechanism in the low-speed position;

FIG. 30 is an elevational view of the second alternative embodiment of the linkage system and drive mechanism in a high-speed position;

FIG. 31 is a perspective view of the second alternative embodiment of the linkage system and drive mechanism in the high-speed position;

FIG. 32 is an exploded view of a cylinder of the mixing cartridge and a base and funnel used to fill the cylinder with components of bone cement;

FIG. 32A is an assembled view of the cylinder, base, and funnel of FIG. 32 enclosed in packaging for transportation;

FIGS. 33-42 illustrate various steps associated with the present invention;

FIG. 43 is an elevational view illustrating multiple arrangements for connecting an actuator, e.g., a power tool or mixing handle, to the mixing shaft;

FIG. 44 is an elevational view of the power tool connected to the mixing shaft using an adapter;

FIGS. 45-46 are perspective views of the adapter;

FIG. 47 is an elevational view of the rotary power tool connected directly to the mixing shaft;

FIG. 48 is an elevational view of the mixing handle connected directly to the mixing shaft;

FIG. 49 is an exploded perspective view of a converter used to convert rotational input into axial and rotational output;

FIG. 49A is a cross-sectional view of an input shaft and an output shaft of the converter of FIG. 49 taken along the line 49A-49A in FIG. 49;

FIG. 50 is an assembled view of the converter connected to the mixing cartridge;

FIG. 51 is an exploded perspective view of an alternative converter used to convert rotational input into axial and rotational output; and

FIG. 52 is an assembled view of the alternative converter connected to the mixing cartridge.

### DETAILED DESCRIPTION OF THE INVENTION

Referring to the Figures, wherein like numerals indicate like or corresponding parts, throughout the several views, a bone cement mixing and delivery system is generally shown. The bone cement mixing and delivery system comprises a mixing cartridge 100 for receiving liquid monomer and powdered copolymer components of bone cement to be mixed, a mixing device (mixing shaft 150 and blade 152) for mixing the components, and a delivery device, e.g., a delivery gun 500, for discharging the bone cement from the mixing cartridge 100 into an anatomical site (not shown). An exemplary use for the bone cement is to secure a prosthetic device used to replace a joint structure such as in a total hip arthroplasty (THA) procedure.

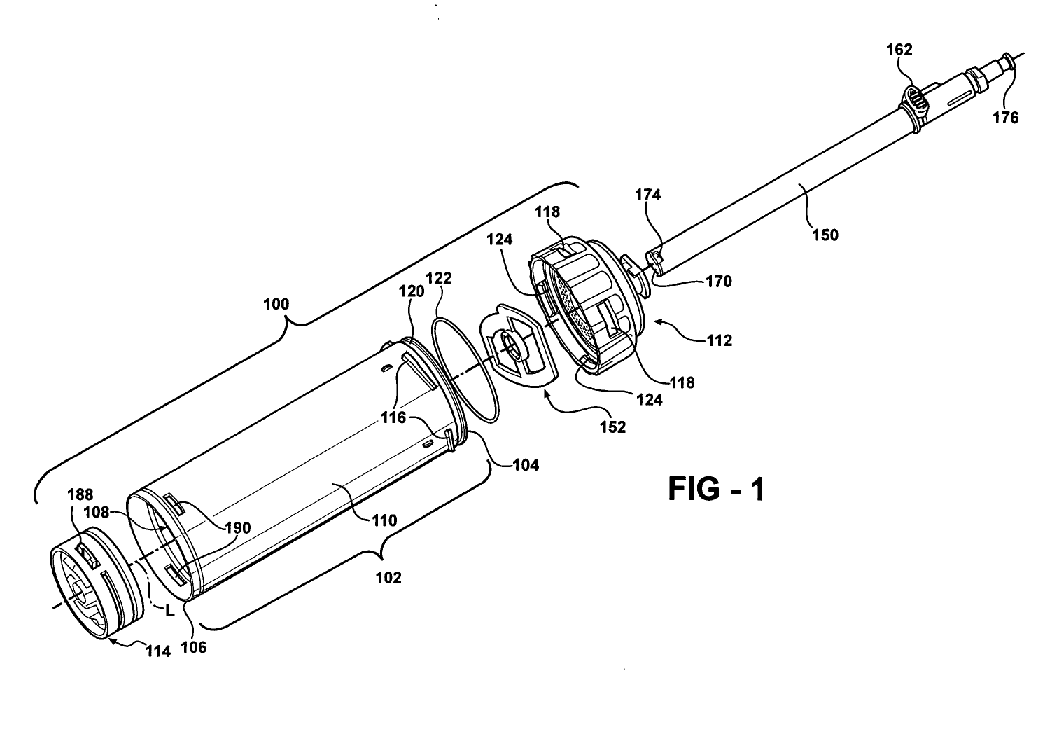

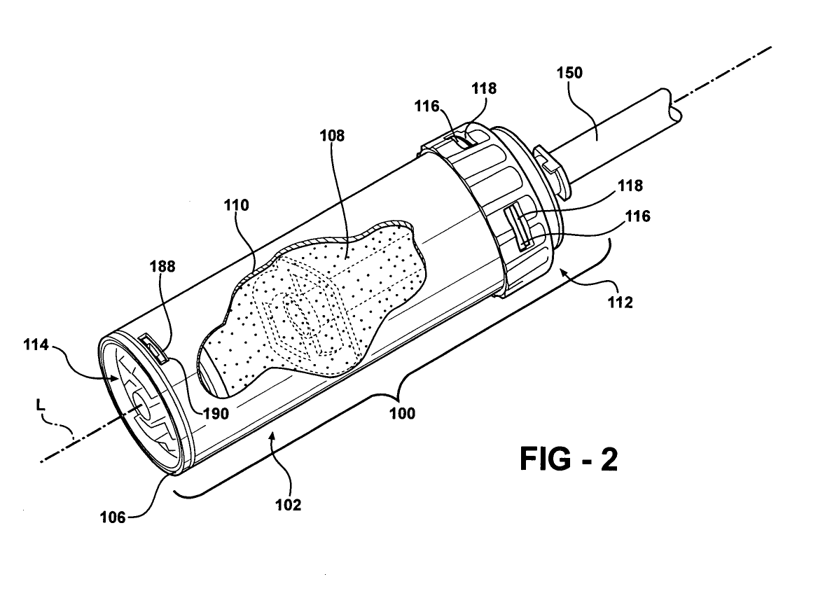

Referring to FIGS. 1 and 2, the bone cement mixing system comprises the mixing cartridge 100 in combination with the mixing shaft 150 and blade 152 used to mix the components of the bone cement in the mixing cartridge 100. The mixing cartridge 100 includes a cylinder 102 having proximal 104 and distal 106 ends. A mixing chamber 108 is defined between the ends 104, 106. The cylinder 102 includes a cylinder wall 110 extending between the ends 104, 106, about a longitudinal axis L. A cap 112 is coupled to the cylinder 102 at the proximal end 104 and a piston 114 is disposed in the cylinder 102 at the distal end 106 such that the mixing chamber 108 is further defined between the cap 112 and the piston 114. The components of the bone cement are placed in the mixing chamber 108 and mixed by the mixing shaft 150 and blade 152, as will be described further below.

In the preferred embodiment, the cylinder 102 has locking strips 116 disposed on the cylinder wall 110 at the proximal end 104 to insert into locking slots 118 on the cap 112. Each of the locking strips 116 include a straight portion lying perpendicular relative to the longitudinal axis L and an angled portion lying at an angle relative to the straight portion. As should be appreciated, the locking strips 116 and locking slots 118 could be reversed, i.e., the locking strips 116 positioned on the cap 112 and the locking slots 118 defined in the cylinder wall 110. The locking strips 116 and locking slots 118 are configured to provide quick locking of the cap 112 onto the cylinder 102 with a one-quarter turn of the cap 112. Those of ordinary skill in the art will appreciate that numerous methods are available for connecting the cap 112 to the cylinder 102, such as mating threads, snap-fit connections, etc. A groove 120 is formed in the cylinder 102 at the proximal end 104 to seat an o-ring seal 122. The o-ring seal 122 assists in sealing the cap 112 to the cylinder 102.

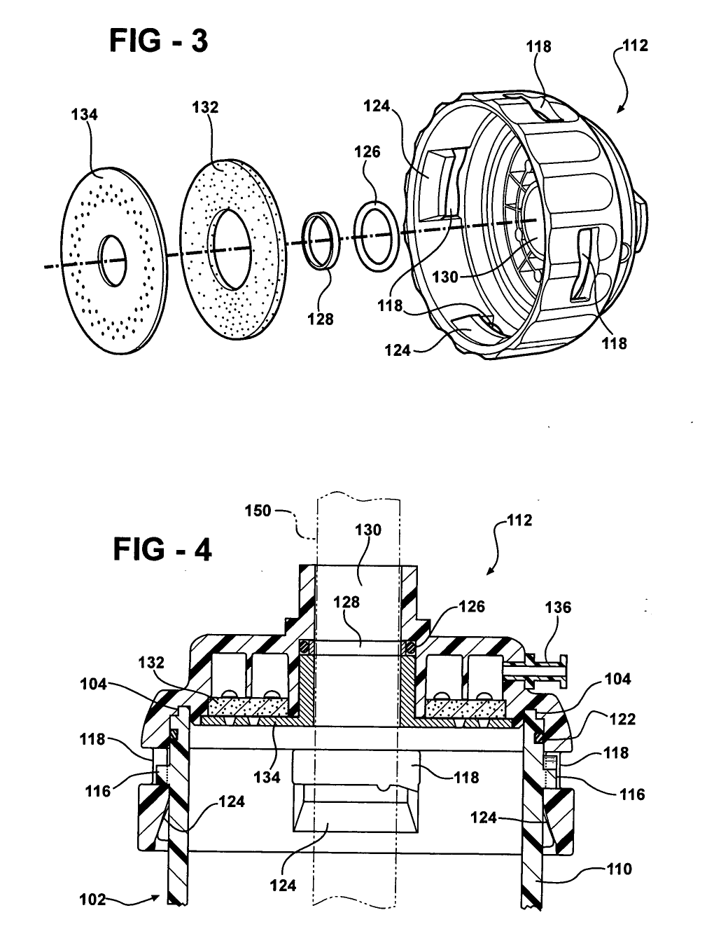

Referring to FIGS. 3-4, the cap 112 includes radially inwardly protruding ramps 124 that lead into the locking slots 118 to facilitate the fit with the locking strips 116 on the cylinder wall 110. When first placing the cap 112 on the cylinder 102, the locking strips 116 are positioned between the ramps 124. As the cap 112 is rotated, the ramps 124 cam the locking strips 116 proximally to urge the proximal end 104 of the cylinder 102 into a sealed relationship with the cap 112, as shown in FIG. 4 (only a portion of the cylinder wall 110 with two locking strips 116 is shown in FIG. 4 for illustrative purposes). In the preferred embodiment, there are four locking strips 116 and four locking slots 118 to facilitate the sealed relationship between the cap 112 and the cylinder 102.

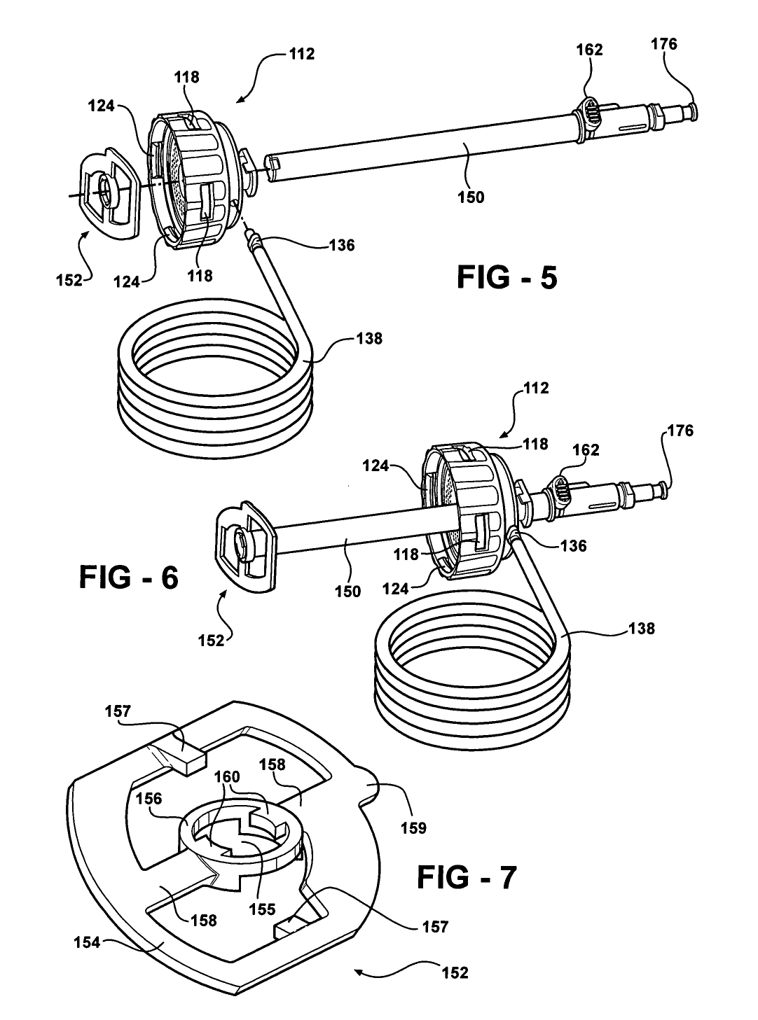

Referring specifically to FIG. 4, an o-ring seal 126 and dynamic seal 128 operate together within an orifice 130 in the cap 112 to movably support and seal to the mixing shaft 150. The mixing shaft 150 slides through the orifice 130 and the dynamic seal 128 and is movably supported therein. The dynamic seal 128 allows nearly frictionless rotational, as well as axial movement of the mixing shaft 150 within the mixing chamber 108 to mix the liquid and powder components of the bone cement, while maintaining a snug fit within the orifice 130. A filter 132 and liner 134 are positioned on an interior of the cap 112 to allow a vacuum to be drawn in the mixing chamber 108 by way of a vacuum port 136. The vacuum port 136 is isolated from the mixing chamber 108 by the filter 132 and liner 134 to prevent fouling of a vacuum pump (not shown). Referring to FIGS. 5-6, a vacuum tube 138 is shown attached to the vacuum port 136 to draw the vacuum in the mixing chamber 108 during mixing.

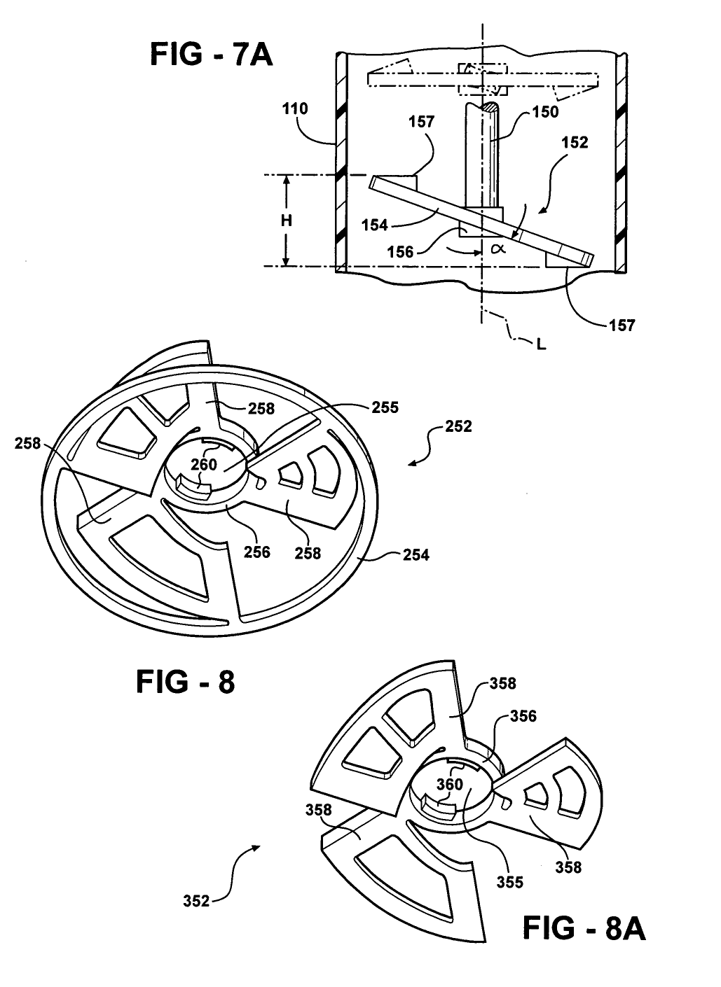

Referring to FIG. 7, the preferred blade 152 used to mix the bone cement is shown. The blade 152 is integrally formed from plastic in one piece and has an outer ring 154 connected to a center hub 156 by vanes 158. Ears 160 protrude radially inwardly from the center hub 156 to facilitate a releasable connection to the mixing shaft 150. The releasable connection is described further below. Referring to FIG. 7A, the outer ring 154 forms an acute angle α with the longitudinal axis L of the cylinder 102 (which is also a rotational mixing axis of the blade 152). The acute angle α is important for efficient mixing of the bone cement. The acute angle α is preferably between twenty and seventy degrees, and more preferably sixty degrees. The blade 152 has an effective height H that is greater than one quarter inch to ensure adequate mixing. Preferably, the effective height H of the blade 152 is approximately one half inch.

Referring back to FIG. 7, two radially inwardly protruding fingers 157 are attached to the outer ring 154. One of the fingers 157 protrudes radially inwardly in a first plane and the other finger 157 protrudes radially inwardly in a second plane spaced from and parallel to the first plane. The center hub 156 is positioned between the planes. The fingers 157 are used to scrape proximal and distal regions of the mixing chamber 108 to ensure complete mixing. A protruding node 159 is also attached to the outer ring 154. The node 159 protrudes radially outwardly to control spacing between the blade 152 and an inner periphery of the cylinder wall 110 by scraping along the inner periphery of the cylinder wall 110 in the mixing chamber 108.

FIGS. 8 and 8A illustrate alternative blades 252, 352 that could also be used to mix the bone cement. Each of the blades 152, 252, 352 is designed to flatten at the proximal end 104 of the cylinder 102 adjacent to the cap 112 after the blade 152, 252, 352 is released from the mixing shaft 150 in the mixing chamber 108. This ensures that the maximum possible amount of bone cement can be discharged from the mixing cartridge 100. In the case of the preferred blade 152, the blade 152 is flexible and the outer wall 154 flattens into a plane perpendicular to the longitudinal axis L and occupied by the center hub 156, as illustrated by hidden lines in FIG. 7A. Thus, the effective height H is reduced and the acute angle α becomes close to ninety degrees. This is accomplished by twisting at the vanes 158. Spaces 155, 255, 355 formed in the center hub 156, 256, 356 ensure that once the blade 152, 252, 352 is flattened, the bone cement can pass through the blade 152, 252, 352 when discharged from the mixing cartridge 100. To further facilitate the discharge of the bone cement past the blades 152, 252, 352, each of the center hubs 156, 256, 356 are sized to partially fit within the aperture 130 defined in the cap 112.

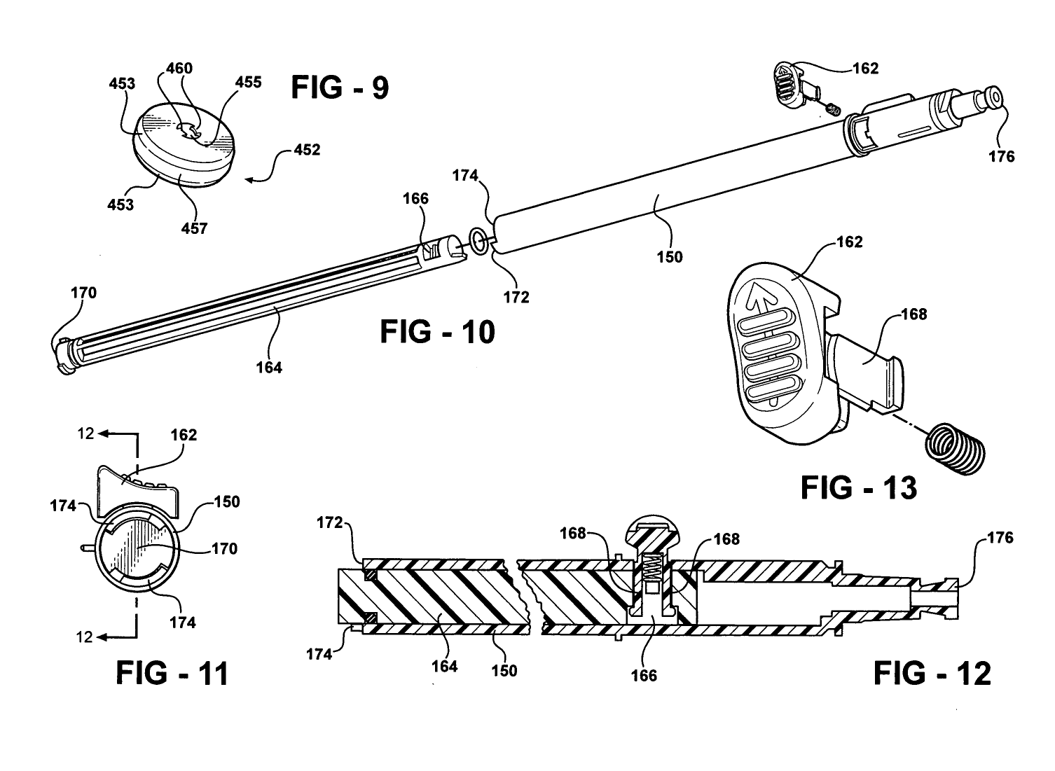

Another alternative blade 452 is shown in FIG. 9. This blade 452 is a relatively thick disk 452 with chamfered ends 453 forming an acute chamfer angle with a sidewall 457. The chamfer angle is preferably sixty degrees. In the preferred embodiment, the disk is about one half inch thick and about one eighth inch less in diameter than the inner periphery of the cylinder wall 110. In one embodiment, the inner periphery of the cylinder wall 110 is about two and one quarter inches in diameter. As should be appreciated, the slight distance between the side wall 457 of the disk 452 and the inner periphery of the cylinder wall 110 creates a shear force on the bone cement as the disk 452 is rotated and moved axially in the mixing chamber 108. The shear force is the force applied to the bone cement to mix the bone cement. This blade 452 also includes a space 455 formed in a center of the disk 452 and ears 460 for releasably attaching to the mixing shaft 150.

Referring to FIGS. 10-13 the mixing shaft 150 has a release latch 162 for releasing the blade 152 from the mixing shaft 150 once mixing of the bone cement is complete. The release latch 162 moves between a holding position and a releasing position. In the holding position, the blade 152 is secured to the mixing shaft 150 to mix the bone cement in the mixing chamber 108. In the releasing position, the blade 152 is released from the mixing shaft 150 to remain in the mixing chamber 108 while the mixing shaft 150 is removed from the cap 112 to make way for a nozzle 204, as will be described further below. The release latch 162 is operatively connected to a latch rod 164, which latches the blade 152 to the mixing shaft 150 in the holding position. The latch rod 164 defines a split cavity 166 for receiving split legs 168 of the release latch 162 in a snap-fit manner. The latch rod 164 is rotatably supported within the mixing shaft 150.

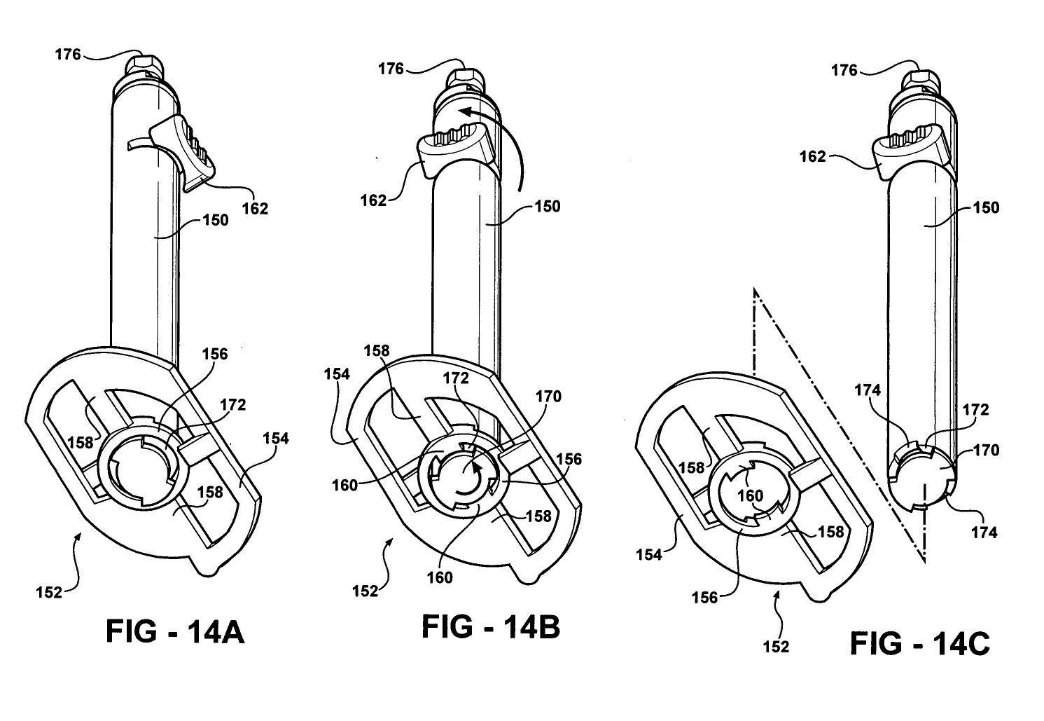

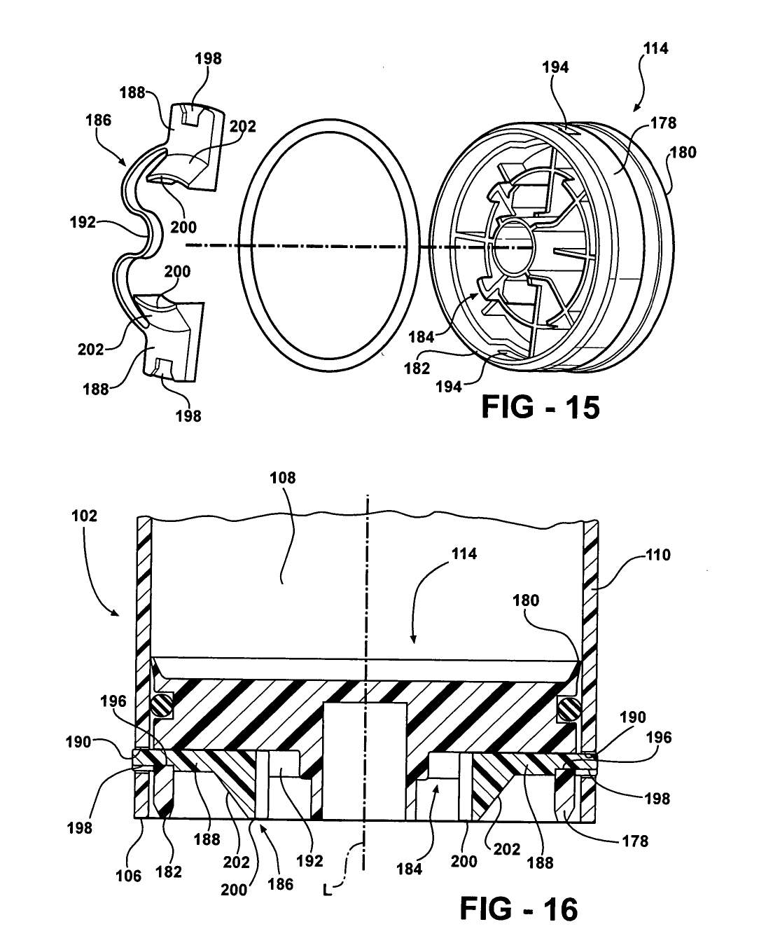

Referring to FIGS. 14A-14C, the transition of the release latch 162 between the holding position and the releasing position is illustrated. Referring first to FIG. 14C, the exposed end 170 of the latch rod 164 is generally “T” shaped. The corresponding end 172 of the mixing shaft 150 has opposed notches 174 that are adapted to receive the ears 160 on the center hub 156 of the blade 152. Initially, the ears 160 are positioned in the notches 174 and the exposed end 170 is positioned over the ears 160 to hold the blade 152 to the mixing shaft 150. See FIG. 14A. To release the blade 152, the release latch 162 is depressed and rotated. Rotating the release latch 162 rotates the latch rod 164 with respect to the mixing shaft 150 thus rotating the exposed end 170 away from the ears 160 to release the blade 152. See FIG. 14B. With the blade 152 released, the mixing shaft 150 is withdrawn from the cap 112 while the blade 152 remains in the mixing chamber 108.

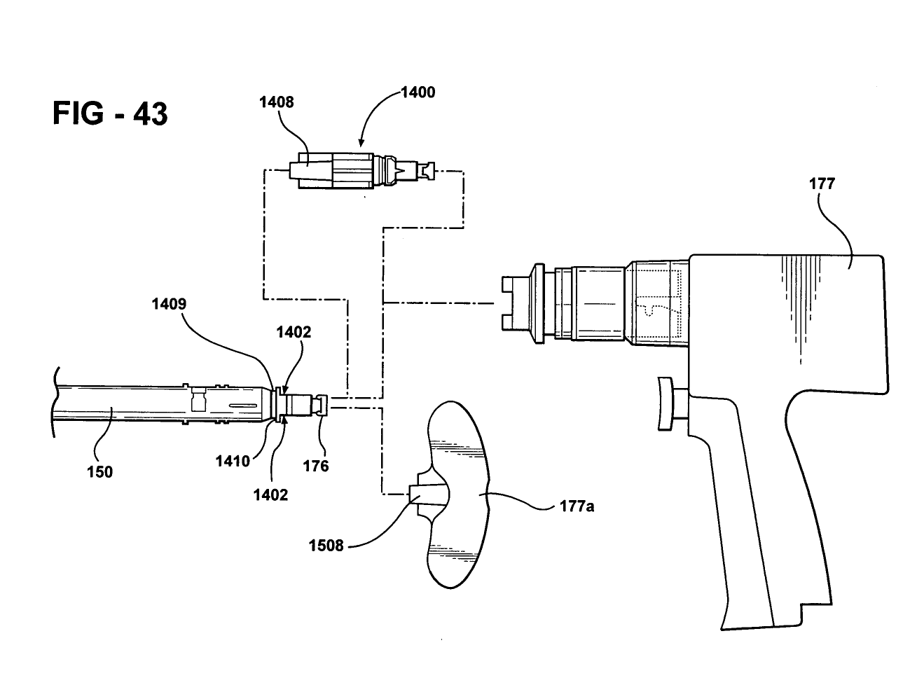

A proximal end 176 of the mixing shaft 150, which represents a portion of the mixing shaft 150 extending outside of the mixing chamber 108 during mixing, is adapted to engage a rotary power tool 177 (see FIG. 43), such as an electric or pneumatic reamer drill, used to rotate the mixing shaft 150 and blade 152 and mix the bone cement. The proximal end 176 of the mixing shaft 150 is operatively connected to the blade 152 to transfer the rotation of the rotary power tool 177 to the blade 152. When the blade 152 is released from the mixing shaft 150, the operative connection is removed. The operative connection is also removed if the portion of the mixing shaft 150 extending outside of the mixing chamber 108 is severed from the rest of the mixing shaft 150 in the mixing chamber 108, as in alternative embodiments. A manually operated mixing handle 177a (see FIG. 43) could engage the mixing shaft 150 at the proximal end 176 to mix the bone cement in other embodiments.

Referring to FIGS. 15-16, the piston 114 is positioned within the distal end 106 of the cylinder 102 to further seal the mixing chamber 108. The piston 114 has a skirt 178 extending about the inner periphery of the cylinder wall 110. The piston 114 also includes a proximal end 180 and a distal end 182 defining a cavity 184.

Referring specifically to FIG. 16, the piston 114 is releasably secured in a locked position in the distal end 106 of the cylinder 102 by a locking member 186. The locking member 186 is disposed in the cavity 184 and includes diametrically opposed locking tabs 188 protruding into diametrically opposed slots 190 defined in the cylinder wall 110 to secure the piston 114 to the cylinder 102. It should be appreciated that the slots 190 could be in the form of any suitable female portion, e.g., slot, groove, channel, etc., used for interlocking with a corresponding male portion such as the locking tabs 188. Furthermore, while the embodiment of FIG. 16 illustrates two-way locking, i.e., the piston 114 being locked from moving proximally and distally, the locking member 186 could also be used for one-way locking, i.e., for preventing only proximal movement of the piston 114.

The locking member 186 is integrally formed from plastic and a resilient portion 192 of the locking member 186 biases the locking tabs 188 radially outwardly from the longitudinal axis L into the slots 190. The resilient portion 192 is in the form of a thin resilient ribbon 192 acting like a spring and extending is a winding shape between the locking tabs 188. The locking tabs 188 couple the locking member 186 to the piston 114 by protruding through carrier slots 194 formed in the skirt 178. In the preferred embodiment, a step 196 protrudes into each of the carrier slots 194 to define a guide for sliding engagement within a channel 198 partially defined in each of the locking tabs 188. In the locked position, the carrier slots 194 are axially and radially aligned with the slots 190 formed in the cylinder wall 110.

The piston 114 is locked at the distal end 106 of the cylinder 102 while the liquid and powder components are added and mixed in the mixing cartridge 100. The piston 114 is released from the locked position after mixing of the bone cement is complete. Release buttons 200, integrally formed with the locking tabs 188, are used to release the piston 114 from the locked position. The release buttons 200 are disposed on the locking tabs 188 and protrude distally therefrom. Each of the release buttons 200 includes a cam surface 202 forming an acute angle with the longitudinal axis L. The piston 114 is released from the locked position by squeezing the release buttons 200 radially inwardly against the bias of the resilient portion 192 to withdraw the locking tabs 188 from the slots 190. This action can be performed either manually or mechanically, as will be described further below. After release from the slots 190, the locking tabs 188 remain coupled to the piston 114 in the carrier slots 194.

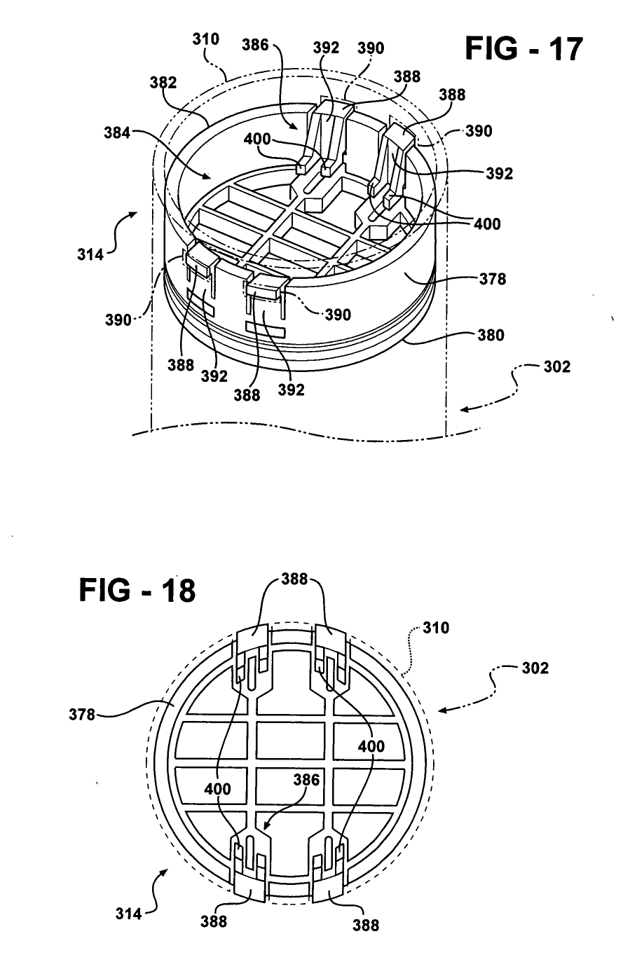

Referring to FIGS. 17-18, an alternative locking member 386 is shown. The alternative locking member 386 includes locking tabs 388 that are biased radially outwardly from the longitudinal axis L of the cylinder 302 to engage the slots 390 in the cylinder wall 310. In this embodiment, four slots 390 are defined in the cylinder wall 310 to receive the locking tabs 388. The resilient portion 392 is further defined as a resilient base 392 resiliently supporting each of the locking tabs 388 on the piston 314 with each of the locking tabs 388 being radially biased outwardly from the skirt 378 of the piston 314 to engage the slots 390 in the cylinder wall 310. The release buttons 400 are further defined as fingers 400 extending radially inwardly toward the longitudinal axis L of the cylinder 302 with the fingers 400 being engageable to urge the locking tabs 388 radially inwardly and withdraw the locking tabs 388 from the slots 390 in the cylinder wall 310 to release the piston 314 from the locked position.

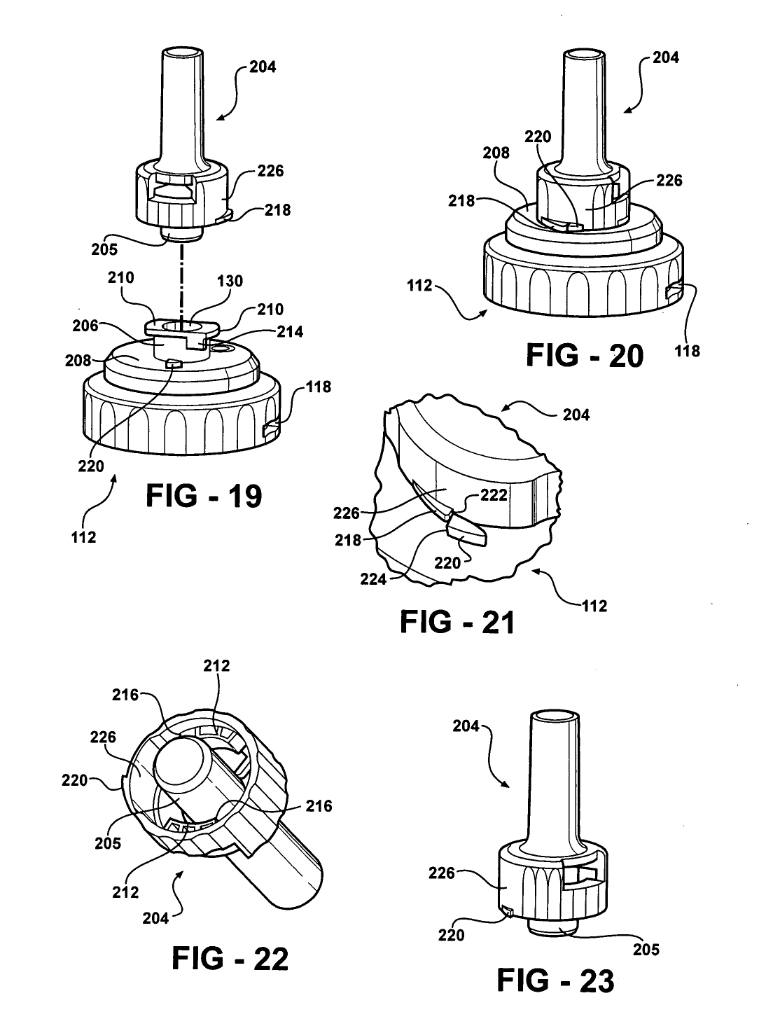

Referring to FIGS. 19-23, once the bone cement is mixed, and the mixing shaft 150 is withdrawn from the cap 112, the nozzle 204 is positioned on the cap 112. In the disclosed embodiment, the nozzle 204 is set in place by pushing a hollow shaft 205 of the nozzle 204 down into the orifice 130 of the cap 112 and then twisting the nozzle 204 slightly, about one-quarter turn. The o-ring seal 126 and dynamic seal 128 positioned within the orifice 130 in the cap 112, which are used to movably support and seal to the mixing shaft 150 (refer briefly to FIG. 4), are also used to seal to the hollow shaft 205. The nozzle 204 is attached to the cap 112 to prepare the mixing cartridge 100 for placement into the delivery gun 500.

The cap 112 has a nipple 206 protruding from an outer surface 208 thereof. The nipple 206 has tabs 210, which engage detent members 212 in the nozzle 204. After the nozzle 204 is fully rotated into position, the tabs 210 fully engage the detent members 212 while being positioned proximal to the detent members 212 to secure the nozzle 204 in place. A stop 214 on the cap 112, best shown in FIG. 19, prevents the nozzle 204 from rotating freely in the clockwise direction after the tabs 210 have engaged the detent members 212. The stop 214 extends downwardly from one of the tabs 210 to abut a side surface 216 of one of the detent members 212 to prevent further clockwise rotation.

The nozzle 204 and cap 112 have first 218 and second 220 locking protrusions. The first locking protrusion 218 acts as a detent and slides over the second locking protrusion 220 to a locked position as illustrated in FIG. 21. In this position, rear flat surfaces 222, 224 of the locking protrusions 218, 220 abut one another to prevent the nozzle 204 from being turned in the opposite direction, thereby preventing removal of the nozzle 204 from the cap 112. The nozzle 204 can be removed by deflecting an outer skirt 226 of the nozzle 204 and rotating the nozzle 204 counterclockwise thereby disengaging the locking protrusions 218, 220. Both the nozzle 204 and cap 112 are formed from plastic, which facilitates the detent-like locking and unlocking of the nozzle 204 to the cap 112.

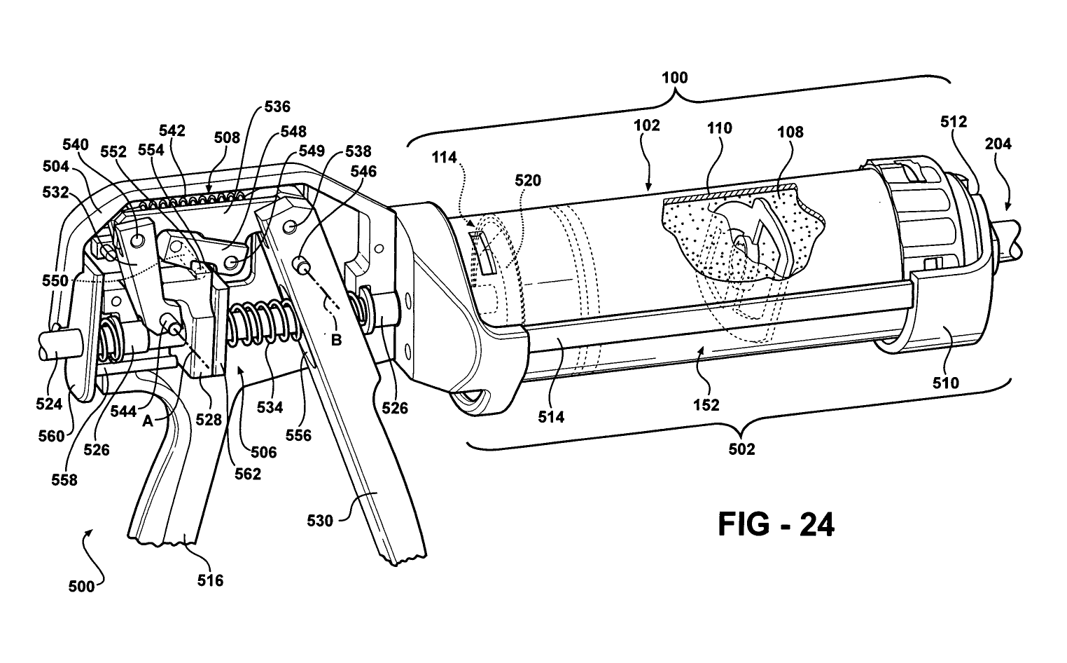

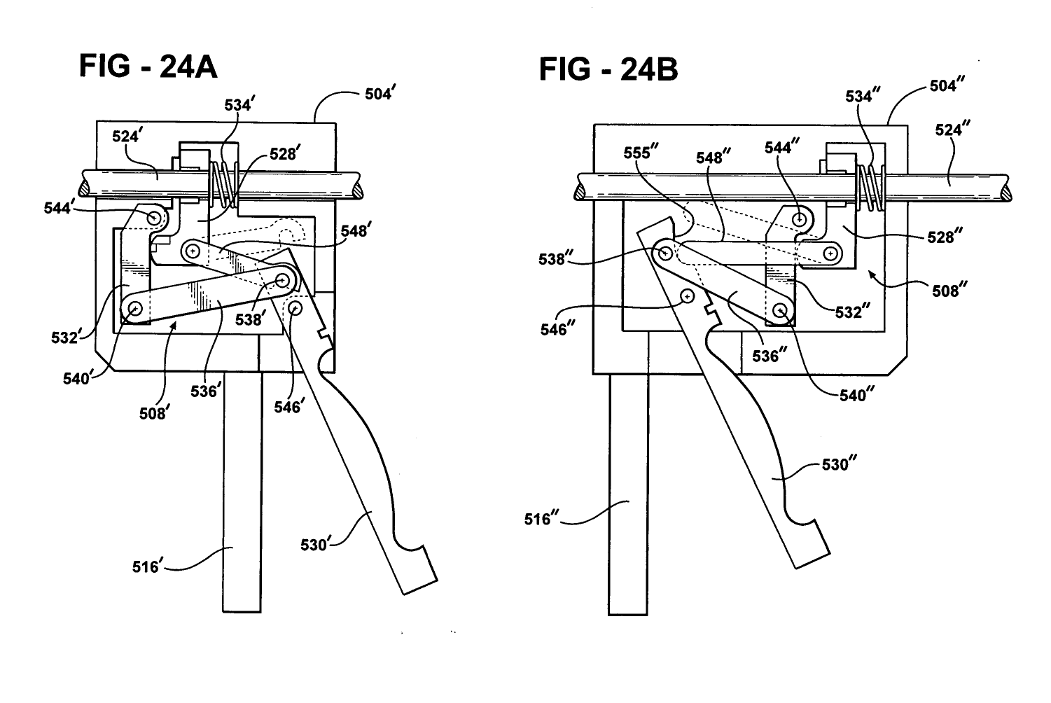

With the nozzle 204 in place, the mixing cartridge 100 is ready to be placed within the delivery-gun 500. Referring to FIG. 24, the delivery gun 500 of the present invention includes a cradle 502 for supporting the mixing cartridge 100 and a casing 504 fixed to the cradle 502 for supporting a drive mechanism 506, a linkage system 508, and corresponding components. The cradle 502 includes an endplate 510, which has an opening 512 for receipt of the nozzle 204. The endplate 510 holds the mixing cartridge 100 in position in the cradle 502. In the preferred embodiment, the casing 504 and the endplate 510 are connected by two connecting bars 514 (one on each side of the mixing cartridge 100) to reduce the weight of the delivery gun 500. A handle 516 is integrally formed with the casing 504 to maneuver the delivery gun 500 during use.

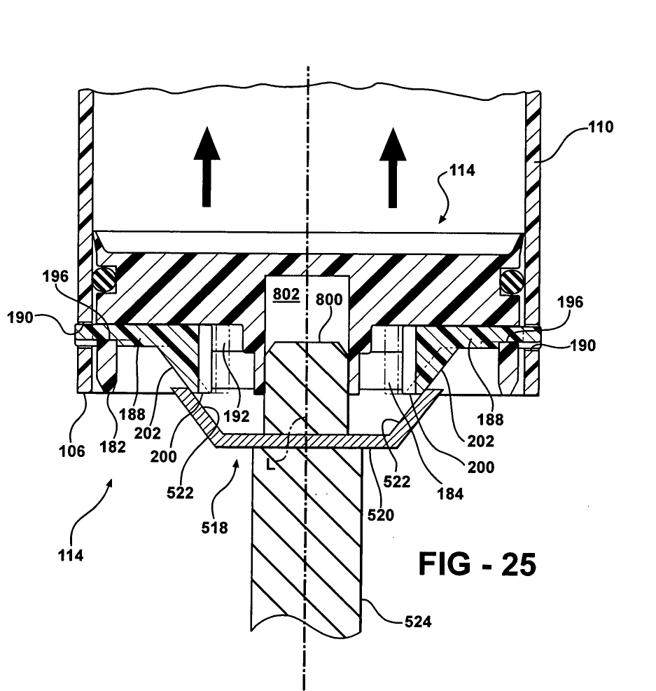

To dispense the bone cement from the mixing cartridge 100, the piston 114 must first be released from the locked position. Referring to FIG. 25, this is accomplished using a release mechanism 518 integrated into the delivery gun 500. Once the mixing cartridge 100 is in place in the cradle 502, a ram disk 520 protrudes into the cavity 184 in the distal end 182 of the piston 114. The release mechanism 518 is integrated into the ram disk 520. The release mechanism 518 includes a bearing surface 522 forming an acute angle with the longitudinal axis L for catching the release buttons 200 to cam the release buttons 200 radially inwardly. More specifically, the cam surfaces 202 of the release buttons 200 slide along the bearing surface 522, while being cammed radially inwardly. This action pulls the locking tabs 188 radially inwardly to withdraw the locking tabs 188 from the slots 190 in the cylinder wall 110 and release the piston 114 from the locked position (when the alternative piston 314 is used, the ram disk has a flat bearing surface that axially presses the fingers 400 proximally to bend each resilient base 392 inwardly and urge the locking tabs 388 radially inward). A centering pin 800 can be used to center the ram disk 520 in a centering cavity 802 of the piston 114 to facilitate the release of the piston 114 from the locked position.

Referring back to FIG. 24, once the piston 114 is released, the piston 114 can be driven through the mixing chamber 108 by the drive mechanism 506 to force the bone cement from the nozzle 204. The drive mechanism 506 includes a drive rod 524 movably supported by bushings 526 in the casing 504. The ram disk 520 is fixed to the drive rod 524. The drive mechanism 506 further includes a first gripper plate 528 responsive to movement of the linkage system 508 upon actuation of a trigger 530. The first gripper plate 528 defines an aperture surrounding the drive rod 524. The first gripper plate 528 frictionally engages the drive rod 524 to advance the drive rod 524. The first gripper plate 528 is urged forward while in frictional contact with the drive rod 524 by the linkage system 508 when the trigger 530 is actuated. The first gripper plate 528 thereby advances the drive rod 524 and ram disk 520 relative to the casing 504 to drive the piston 114 and force the bone cement from the mixing cartridge 100. The trigger 530 is pivotally supported by the casing 504 and operatively connected to the drive mechanism 506 to advance the drive mechanism 506 upon actuation of the trigger 530.

The linkage system 508 includes a first link 532, which is pivotally mounted to the casing 504 about a pivot axis A adjacent to the first gripper plate 528. The first link 532 is adapted to engage the first gripper plate 528 when the first link 532 pivots about the pivot axis A. A second link 536 pivotally interconnects the trigger 530 to the first link 532 via support pins 538, 540. The links 532, 536 and trigger 530 are interconnected to move in unison upon rotation of the trigger 530 about a second pivot axis B. When the trigger 530 is pulled, the second link 536 rotates the first link 532 about the pivot axis A, which engages the first gripper plate 528 and urges the first gripper plate 528 forward while the first gripper plate 528 is in frictional engagement with the drive rod 524 thereby advancing the drive rod 524. A return spring 542 returns the links 532, 536 and the trigger 530 to an initial position upon release of the trigger 530. At the same time, a first spring 534 momentarily disengages the first gripper plate 528 from the drive rod 524 to slide the first gripper plate 528 back to an initial position to await the next pull of the trigger 530. The casing 504 pivotally supports the first link 532 and the trigger 530 about the pivot axes A and B via support pins 544, 546.

A speed-changing link 548 is pivotally connected to the second link 536 about a support pin 549. The speed-changing link 548 selectively pivots into and out from engagement with the first gripper plate 528 by way of a switch 550. The speed-changing link 548 pivots between a high-speed position and a low-speed position about the support pin 549 (the low-speed position is shown in FIG. 24). The high-speed position corresponds to faster advancement of the drive rod 524 at a lower force. This allows the user to quickly advance the drive rod 524 to drive the piston 114 and dispense high volumes of bone cement at low pressure. The low-speed position corresponds to slower advancement of the drive rod 524 at a higher force, which exerts more force on the piston 114 to pressurize the bone cement.

The first gripper plate 528 and the speed-changing link 548 have complementary first and second coupling devices 552, 554 used to couple the first gripper plate 528 with the speed-changing link 548 in the high-speed position. More specifically, in the embodiment of FIG. 24, the first gripper plate 528 has a shoulder 552 that is received within a channel 554 on the speed-changing link 548. The speed-changing link 548 engages the shoulder 552 in the high-speed position. In the high-speed position, a user's gripping force is transmitted through the trigger 530 to the second link 536 and the speed-changing link 548 to engage the first gripper plate 528 and advance the drive rod 524. The speed-changing link 548 is isolated from the first gripper plate 528 in the low-speed position. The low-speed position corresponds to the speed-changing link 548 being switched or disconnected from the shoulder 552. In the low-speed position, the user's gripping force is transmitted through the trigger 530 to both the first 532 and second 536 links to engage the first gripper plate 528 and advance the drive rod 524. This results in slower advancement of the drive rod 524, but at a much higher mechanical advantage than the high-speed position. As a result, the user can better pressurize the bone cement during injection.

The pivot axes A and B and the links 532, 536, 548 are positioned above the drive rod 524, while the trigger 530 extends below the drive rod 524. A channel 556 defined in the trigger 530 facilitates this configuration. There are several advantages to this configuration. Moving the second pivot axis B away from a user's hand results in better usage of the stronger index and ring fingers by allowing those fingers more travel distance as the trigger 530 is actuated. This configuration also allows the handle 516 to be closer to the drive rod 524, which is believed to reduce wrist strain when the user pushes the delivery gun 500 forward during cement pressurization. Another benefit is that it allows for a more streamlined casing design and better weight distribution.

In one embodiment, shown in FIG. 24, a secondary gripper plate 562 is mounted about the drive rod 524 adjacent to the first gripper plate 528. The addition of one or more secondary gripper plates 562 to the first gripper plate 528 adds strength to the delivery gun 500 while still permitting proper operation. By using two or more gripper plates 528, 562, increased frictional contact with the drive rod 524 is obtained without adversely affecting performance.

A release pin 558 disengages the gripper plates 528, 562 to allow a user to freely move the drive rod 524 by hand. The release pin 558 is connected to a retainer plate 560 and is adapted to engage the first gripper plate 528. When the retainer plate 560 is pushed by the user, the release pin 558 engages the first gripper plate 528 which forces the first gripper plate 528 to tilt back against the bias of the first spring 534 thus releasing the drive rod 524. Any secondary gripper plates 562 follow. As should be appreciated, pushing the retainer plate 560 also pivots the retainer plate 560 releasing its engagement with the drive rod 524. With both the retainer plate 560 and the gripper plates 528, 562 released, the drive rod 524 is free to move. This allows the user to manually move the drive rod 524 with respect to the casing 504.

The delivery gun 500 is unique among bone cement guns with a friction-plate mechanism in the way that it handles wear and deformation of the gripper plates 528, 562. In the disclosed embodiments, the gripper plates 528, 562 are tilted by the first spring 534 into frictional contact with the drive rod 524. Regardless of the amount of wear or deformation of the gripper plates 528, 562 or the drive rod 524, the gripper plates 528, 562 require no further tilting to engage the drive rod 524 upon actuation of the trigger 530. Thus, advancement of the drive rod 524 is produced over the entire actuation of the trigger 530 and efficiency is maintained throughout the life of the delivery gun 500.

Referring to FIGS. 24A and 24B, alternatives of the linkage system 508′ and 508″ are shown. These alternatives are represented with similar numerals to the embodiment of FIG. 24 to indicate like parts. FIG. 24A illustrates a configuration of the linkage system 508′ in which the linkage system 508′ lies beneath the drive rod 524′. Furthermore, the speed-changing link 548′ in this embodiment is pivotally connected to the first gripper plate 528′ and includes a hook-shaped end to engage the support pin 538′ in the high-speed position and disengage the support pin 538′ in the low-speed position. FIG. 24B illustrates a configuration of the linkage system 508″ in which the first gripper plate 528″ is pushed by the linkage system 508″, as opposed to being pulled by the linkage system 508 and 508′ in FIGS. 24 and 24A. Here, the speed-changing link 548″ is pivotally connected to the first gripper plate 528″ to pivot into engagement with a notch 555″ defined in the trigger 530″ in the high-speed position and out from engagement with the notch 555″ in the low-speed position. These alternatives of the linkage system 508′ and 508″ illustrate the flexibility of design, e.g., the selection of mechanical advantage, provided by the linkage system of the present invention.

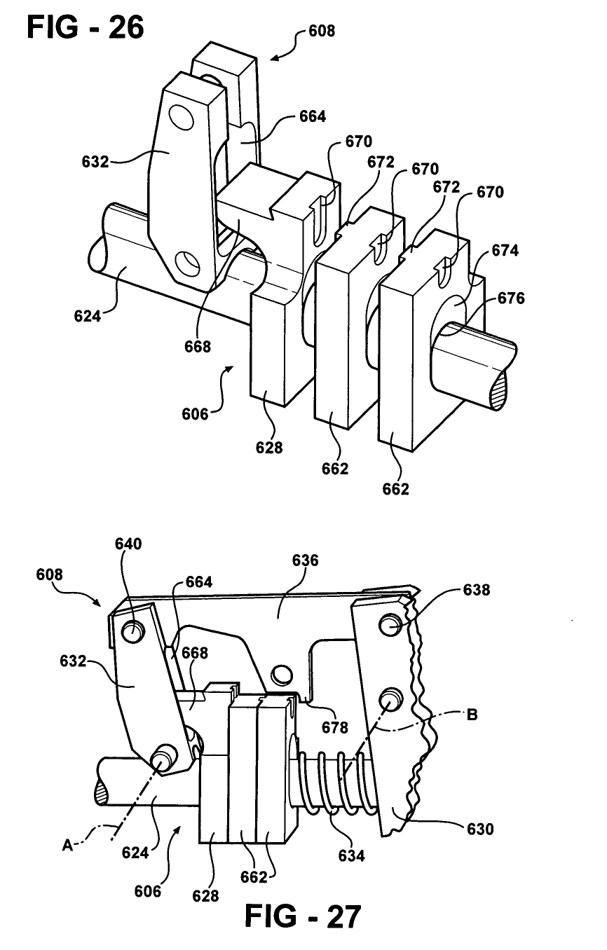

Referring to FIGS. 26-27, an alternative embodiment of the drive mechanism 606 and linkage system 608 is shown (only a portion of the drive mechanism 606 and linkage system 608 is shown for illustrative purposes). In this embodiment, the linkage system 608 comprises the same components as previously described with an improved first link 632 and gripper plates 628, 662. In this embodiment, a plurality of secondary gripper plates 662 are aligned along the drive rod 624 next to the first gripper plate 628. The first link 632 defines a female recess 664 and the first gripper plate 628 includes a male member 668 for mating engagement with the female recess 664. The secondary gripper plates 662 are aligned relative to the first gripper plate 628 via mating notches 670 and pegs 672 formed therein. The notches 670 and pegs 672 assume the same shape to mate with one another and maintain alignment. This arrangement minimizes alignment changes that may cause slipping or uneven wear. The arrangement also reduces contact between the gripper plates 628, 662 and an interior wall of the casing 504. The gripper plates 628, 662 are shown spaced in FIG. 26 for illustration only. In practice, the gripper plates 628, 662 abut one another, as shown in FIG. 27.

In this embodiment, each of the gripper plates 628, 662 also defines a pair of semi-spherical grooves 674. In FIG. 26, only the first of the pair of grooves 674 are shown in each of the gripper plates 628, 662. The other of the pair of grooves 674 is located in a rear surface of each of the gripper plates 628, 662, cater-cornered from the first of the pair of grooves 674. These grooves 674 increase the frictional contact with the drive rod 624. When the gripper plates 628, 662 are urged forward while in frictional engagement with the drive rod 624 by the first link 632, a substantial portion of a rim 676 defined by each of the grooves 674 frictionally contacts the drive rod 624.

Referring to FIG. 27, autoclave sterilization of the delivery gun 500 can create a tendency for the gripper plates 628, 662 to adhere to the drive rod 624 beyond their initial positions when the trigger 630 is released. In this situation the first spring 634 cannot produce enough force to disengage the gripper plates 628, 662 from the drive rod 624, and the gripper plates 628, 662 do not return to their initial positions. FIG. 27 shows a way to prevent this condition. A striker 678, in the form of a downwardly protruding portion of the second link 636, closely follows one of the gripper plates 628, 662 during actuation of the trigger 630. In the event that any of the gripper plates 628, 662 do not properly disengage the drive rod 624 upon release of the trigger 630, the striker 678 will contact the notch 670 in the closest gripper plate 628, 662 and dislodge the gripper plate 628, 662 from the drive rod 624. The first spring 634 can then properly return the gripper plates 628, 662 to their initial positions.

A coating has been added to an exterior of each of the gripper plates 528, 562, 628, 662 in FIGS. 24 and 26-27. The coating increases lubricity and corrosion resistance. This facilitates sliding between the gripper plates 528, 562, 628, 662 as they engage the drive rod 524, 624. The coating also reduces corrosion due to autoclave sterilization that may cause the gripper plates 528, 562, 628, 662 to adhere to one another and prevent proper engagement with the drive rod 524, 624. The coating used may be Electroless-Nickel with polytetrafluoroethylene (PTFE) or other like coatings possessing the same or similar properties.

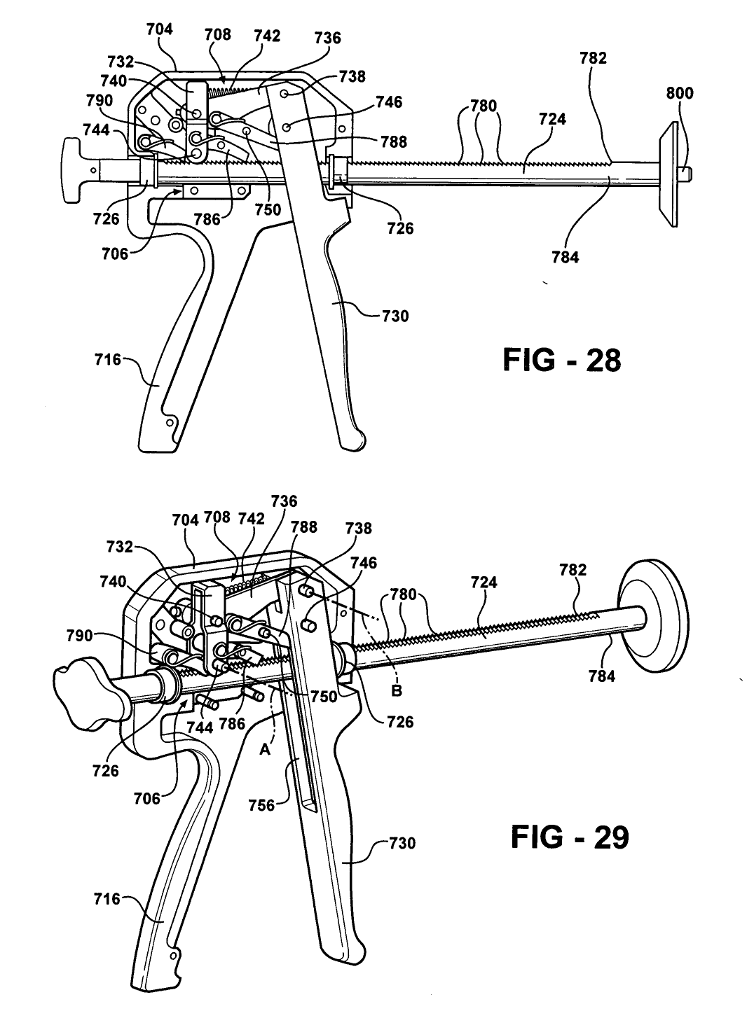

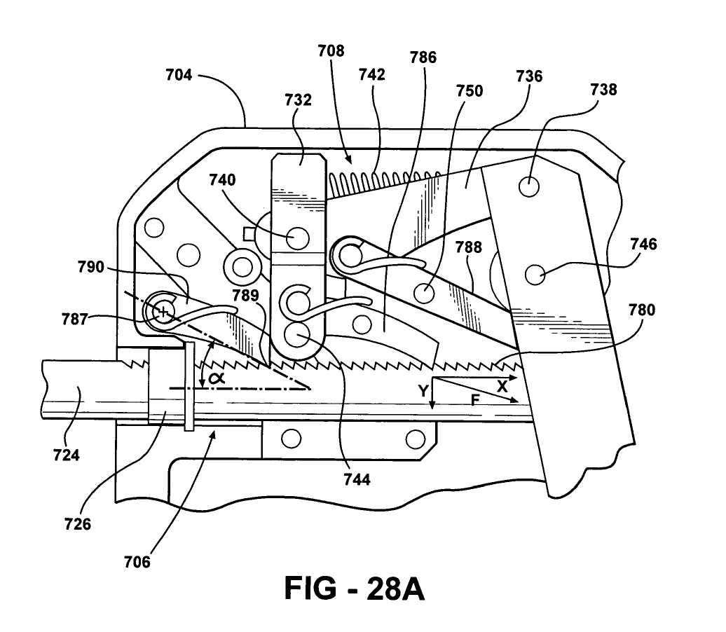

Referring to FIGS. 28-31, another alternative embodiment of the drive mechanism 706 and linkage system 708 is shown. This embodiment also provides selective high-speed and low-speed advancement of the drive rod 724. This alternative drive mechanism 706 eliminates the gripper plate by providing teeth 780 on the drive rod 724. A cross-section of the drive rod 724 shows the teeth 780 on a flat upper surface 782, while a lower surface 784 is smooth and round. The first link 732, which in previous embodiments urged the first gripper plate 528, 628 forward with the drive rod 524, 624, now pivotally supports a first pawl member 786. The first pawl member 786 is spring-biased into engagement with the teeth 780.

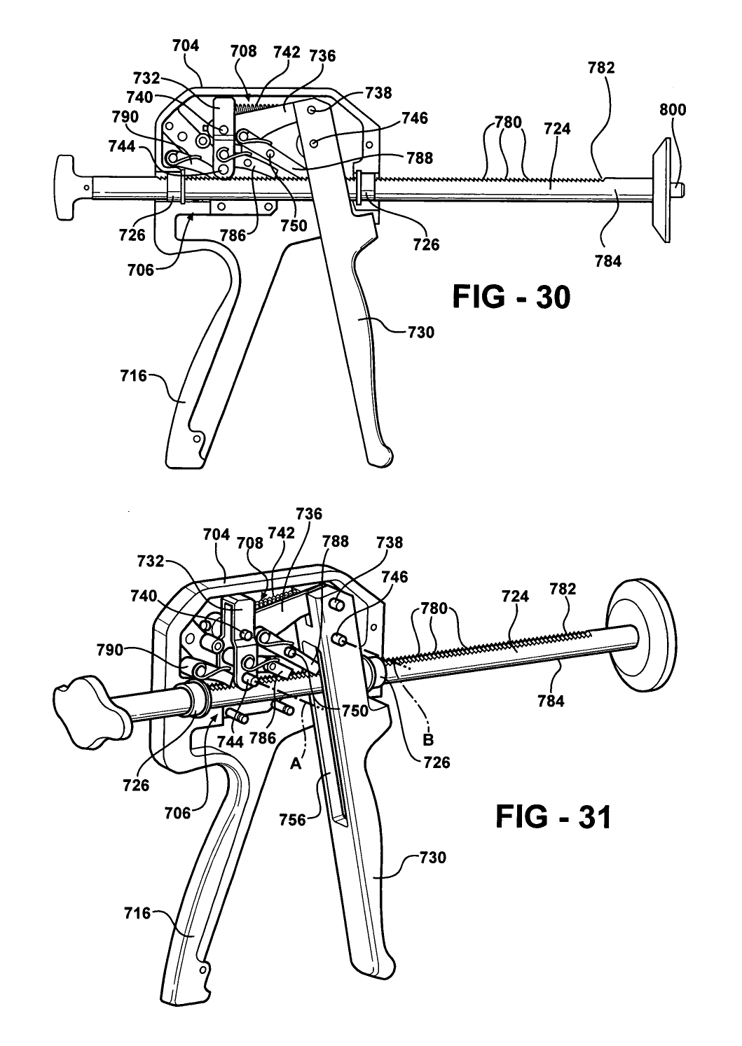

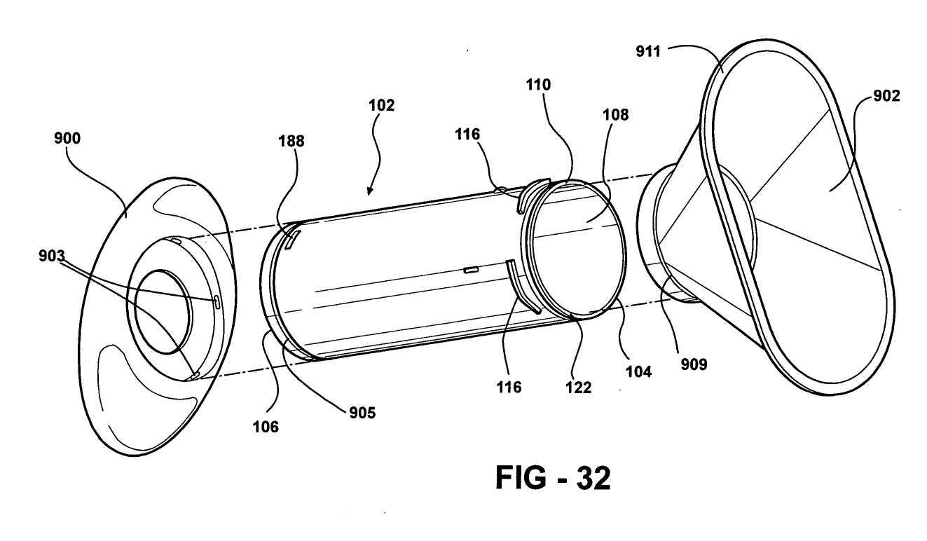

A second pawl member 788 is pivotally supported by the second link 736. The second pawl member 788 is pivotable between a high-speed position in which the second pawl member 788 is spring-biased into engagement with the teeth 780 to advance the drive rod 724, and a low-speed position in which the second pawl member 788 is disengaged and isolated from the teeth 780. In the low-speed position, the first pawl member 786 advances the drive rod 724. The low-speed position is illustrated in FIGS. 28-29. In the high-speed position, with the second pawl member 788 engaging the teeth 780, the first pawl member 786 remains in engagement with the teeth 780, but only ratchets along the teeth 780 as the second pawl member 788 advances the drive rod 724. The high-speed position is illustrated in FIGS. 30-31. The principle of increasing mechanical advantage in the low-speed position relative to the high-speed position also applies in this embodiment.

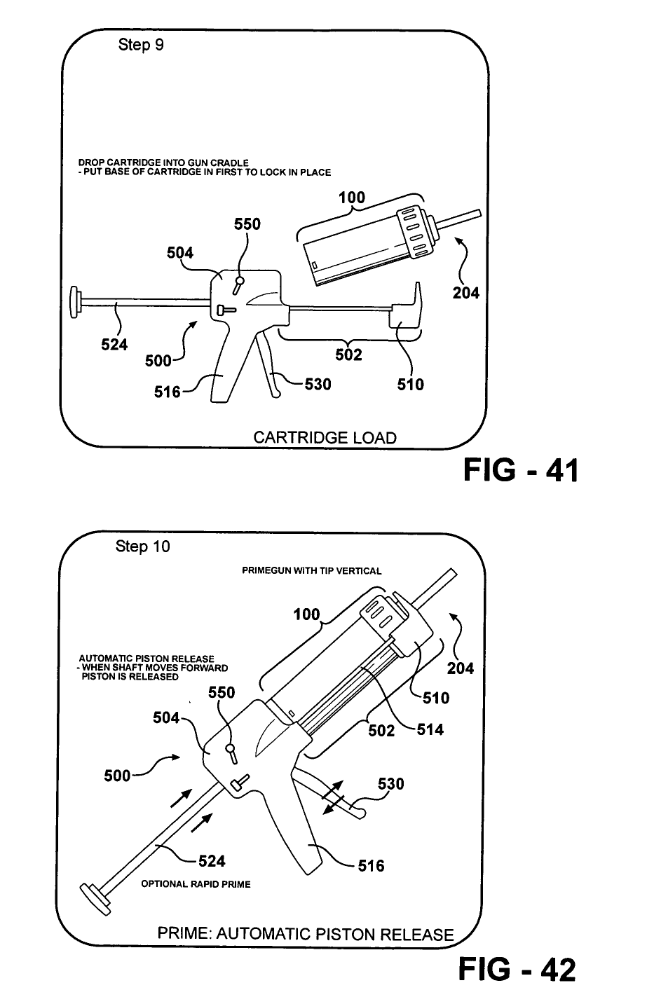

The switch 750 is used to pivot the second pawl member 788 out from engagement with the teeth 780 of the drive rod 724 in the low-speed position (see FIGS. 28-29) and into engagement with the teeth 780 in the high-speed position (see FIGS. 30-31). A switch similar to that shown in U.S. Pat. No. 5,431,654 to Nic, herein incorporated by reference, can be used for this purpose. The switch 750 extends through the casing 704 and terminates in a button that is manipulated by a user to move the second pawl member 788 between the high-speed and low-speed positions (see briefly FIGS. 41-42). This also applies to the switch 550 used to move the speed-changing link 548 in previous embodiments.

In this embodiment, the retainer plate 560 can be removed. In its place, a spring-biased non-return pawl member 790 retains the drive rod 724 in position upon advancement. The drive rod 724 can be freely moved in the casing 704 by rotating the drive rod 724 one hundred and eighty degrees such that the pawl members 786, 788, 790 are out of engagement with the teeth 780. Upon such rotation, the pawl members 786, 788, 790 ride on the smooth lower surface 784 of the drive rod 724 allowing the user to freely pull the drive rod 724 relative to the casing 704. This is generally disclosed in the '654 patent to Nic.

Each of the pawl members 786, 788, 790 are pivotally supported by pins. Springs, such as those shown in the '654 patent to Nic, bias the pawl members into engagement with the teeth 780 on the drive rod 724 (except when the switch 750 acts against the bias of the spring in the low-speed position to disengage the second pawl member 788 from the teeth 780). Referring to FIG. 28A, a force vector F is shown to illustrate the force placed on the drive rod 724 by the first pawl member 786 when the second pawl member 788 is in the low-speed position. As shown, the X component of the force vector F (along the drive rod 724) is considerably larger than the Y component of the force vector F (transverse to the drive rod 724). This configuration is important to reduce the stress placed on the bushings 726 as the drive rod 724 moves through the bushings 726. Preferably, the X component is from 1 to 6 times larger than the Y component, and more preferably, from 2 to 3 times larger than the Y component. Furthermore, the non-return pawl member 790 is arranged such that a reference line passing through a pivot axis 787 of the non-return pawl member 790 and an engaging end 789 of the non-return pawl member 790 forms an acute angle α with the drive rod 724 that is from 0 to 45 degrees. This minimizes reverse travel of the drive rod 724 after the trigger 730 has been released by reducing the travel and swing arc of the non-return pawl member 790 between the teeth 780. This configuration also applies to the first pawl member 786. Additionally, the first pawl member 786 and the non-return pawl member 790 are curved along their lengths from their pivot axes to their engaging ends to better fit between the teeth 780.

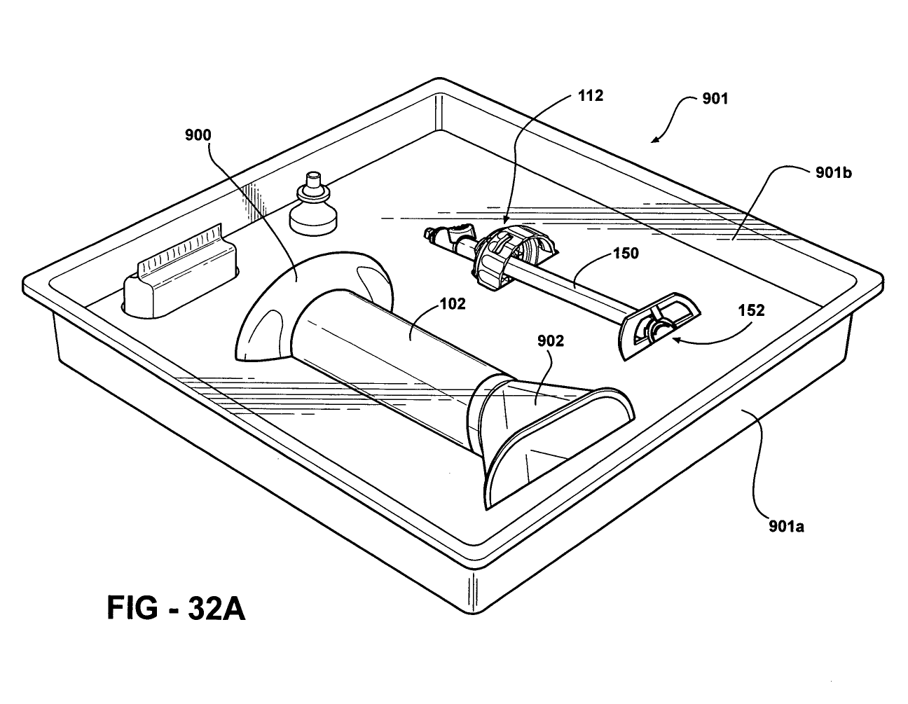

Referring to FIG. 32, a bone cement loading assembly is shown. The bone cement loading assembly comprises a base 900 supporting the cylinder 102 while loading the liquid and powder components of the bone cement into the mixing chamber 108. The base includes a cavity for receiving the distal end 106 of the cylinder 102. Detents 903 are formed in the cavity. A groove 905 is defined in an outer surface of the cylinder 102 to receive the detents 903 and facilitate a snug fit between the base 900 and the cylinder 102. It should be appreciated that the detents 903 could be formed on the cylinder 102 with the groove 905 defined in the base 900. The distal end 106 of the cylinder 102 may also be press fit into the base 900. The base 900 is oblong and oval in shape to fully support the cylinder 102 on a work surface, while the cavity is circular in shape to fit the circular shaped cylinder 102. A funnel 902 couples to the cylinder 102 to channel the powder into the cylinder 102 during loading. The funnel 902 includes a proximal end 911 having an oblong oval-shaped periphery to facilitate the loading of the powder into the mixing chamber 108 and a distal end 909 having a circular periphery to snugly fit inside the proximal end 104 of the cylinder 102.

In FIG. 32A, the bone cement loading assembly is shown pre-assembled in packaging 901 in a ready-to-use state. This bone cement loading system provides for transportation of the bone cement loading assembly in the ready-to-use state. The packaging 901 preferably comprises a tray 901a with the cylinder 102, base 900, and funnel 902 assembled together and lying in the tray 901a. A cover 901b is placed over the tray 901a to enclose the cylinder 102, base 900, and funnel 902 therein. The tray 901a and cover 901b could be formed from transparent, flexible, sterilizable materials, or more rigid, opaque, sterilizable materials, or any combination thereof. In the tray 901a, the base 900 and the funnel 902 are coupled to the cylinder 102 to present the bone cement loading assembly to a user in the pre-assembled, ready-to-use state. Furthermore, the bone cement loading assembly is sterilized and remains sterilized in the packaging 901.

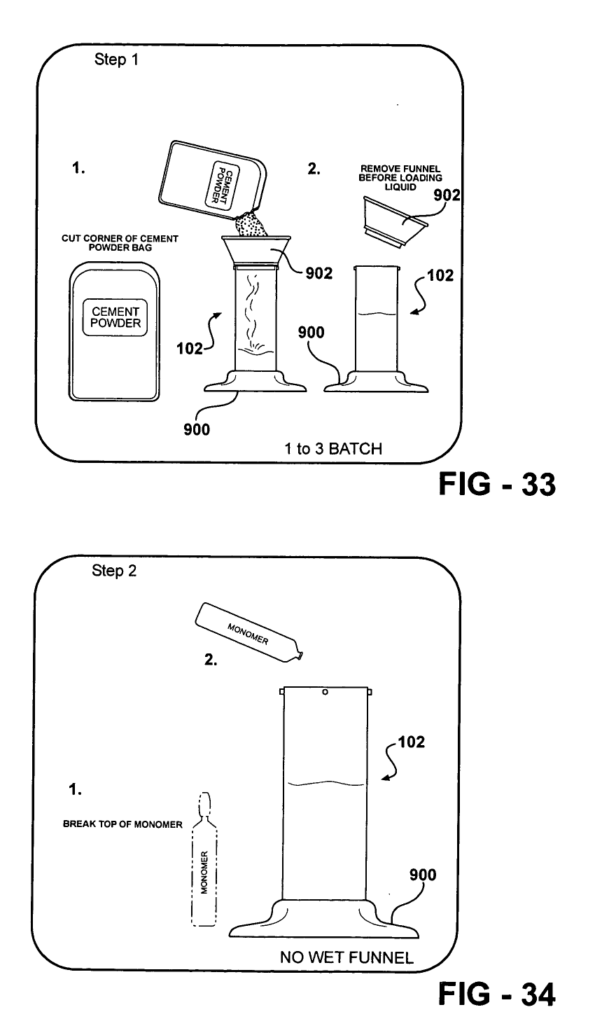

FIGS. 33-42 illustrate ten steps for preparing and injecting the bone cement. The mixing cartridge 100, delivery gun 500, and other components are generically shown in each step for illustrative purposes only.

In STEP 1, shown in FIG. 33, the bone cement loading assembly, i.e., the pre-assembled cylinder 102, base 900, and funnel 902, is removed from the packaging 901 and the powder is poured into the mixing chamber 108 through the funnel 902.

In STEP 2, shown in FIG. 34, after the powder is poured into the mixing chamber 108, the funnel 902 is released, and the liquid component, e.g., liquid monomer, of the bone cement is added. In this manner, the present invention avoids wetting of the funnel 902 and the associated clean-up.

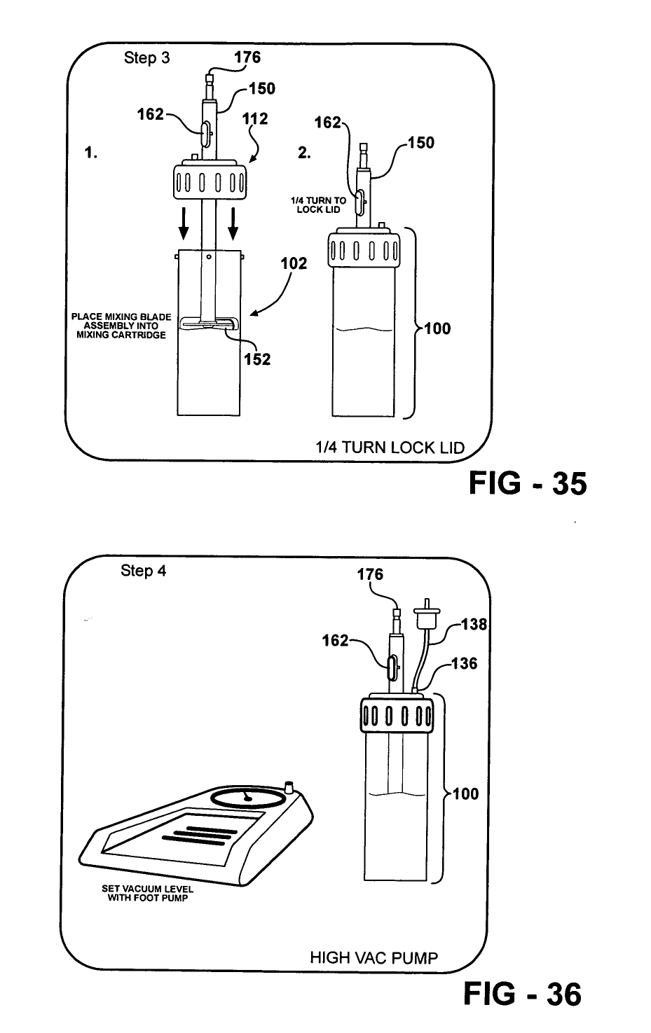

In STEP 3, shown in FIG. 35, the cap 112 with the mixing shaft 150 and blade 152 supported therein is attached to the cylinder 102.

In STEP 4, shown in FIG. 36, the vacuum line 138 is attached to the vacuum port 136 and a vacuum is drawn in the mixing chamber 108 with the liquid and powder components therein.

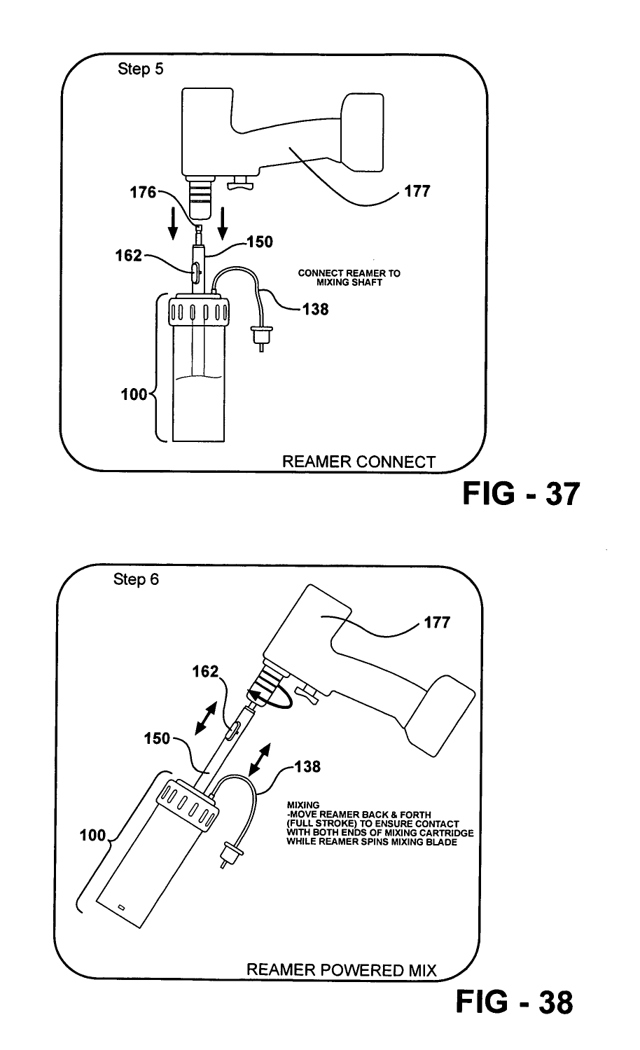

In STEP 5, shown in FIG. 37, with the vacuum drawn, the power tool (reamer) is then connected to the mixing shaft 150. In alternative embodiments, the mixing handle 177a is connected to the mixing shaft 150.

In STEP 6, shown in FIG. 38, with the vacuum still drawn, the mixing shaft 150 is moved axially and rotationally with respect to the mixing cartridge 100. As previously discussed, this can be accomplished by using the mixing handle 177a or by using the rotary power tool 177. The blade 152 (not shown in FIG. 38) is moved axially the entire extent of the mixing cartridge 100 while rotating to ensure that the liquid and powder components are fully mixed.

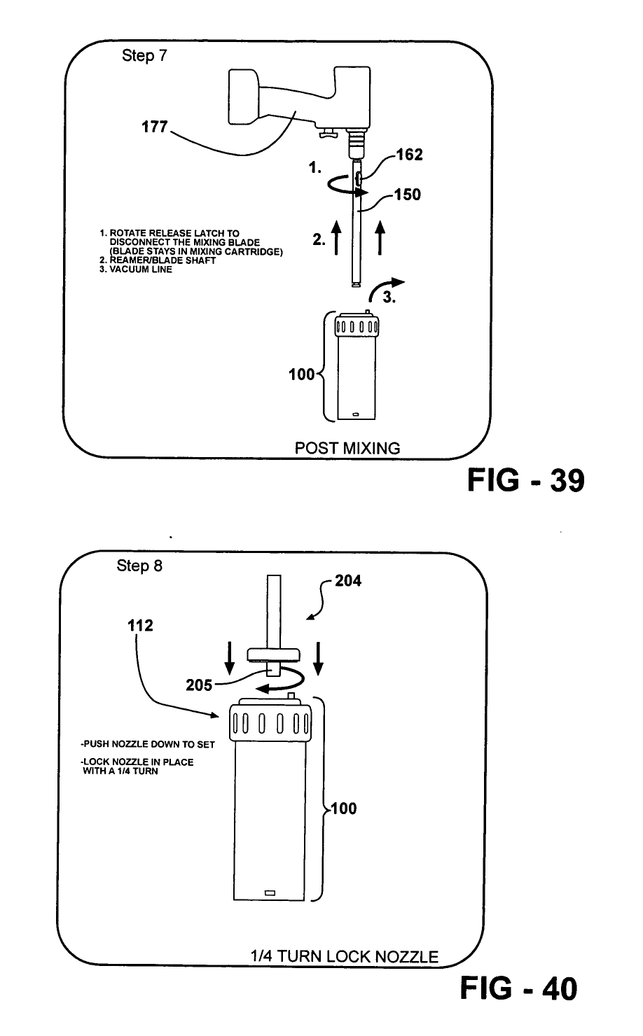

In STEP 7, shown in FIG. 39, once mixed, the release latch 162 is moved to release the blade 152 (not shown in FIG. 39). The blade 152 remains in the mixing chamber 108 once released. The mixing shaft 150 is then removed from the mixing cartridge 100. Mixing is now complete.

In STEP 8, shown in FIG. 40, the nozzle 204 is pushed down on the cap 112 and rotated into place.

In STEP 9, shown in FIG. 41, the mixing cartridge 100 is positioned in the cradle 502.

In STEP 10, shown in FIG. 42, the piston 114 is released from the distal end 106 of the cylinder 102 and the delivery gun 500 is primed and ready to discharge the bone cement from the mixing cartridge 100.

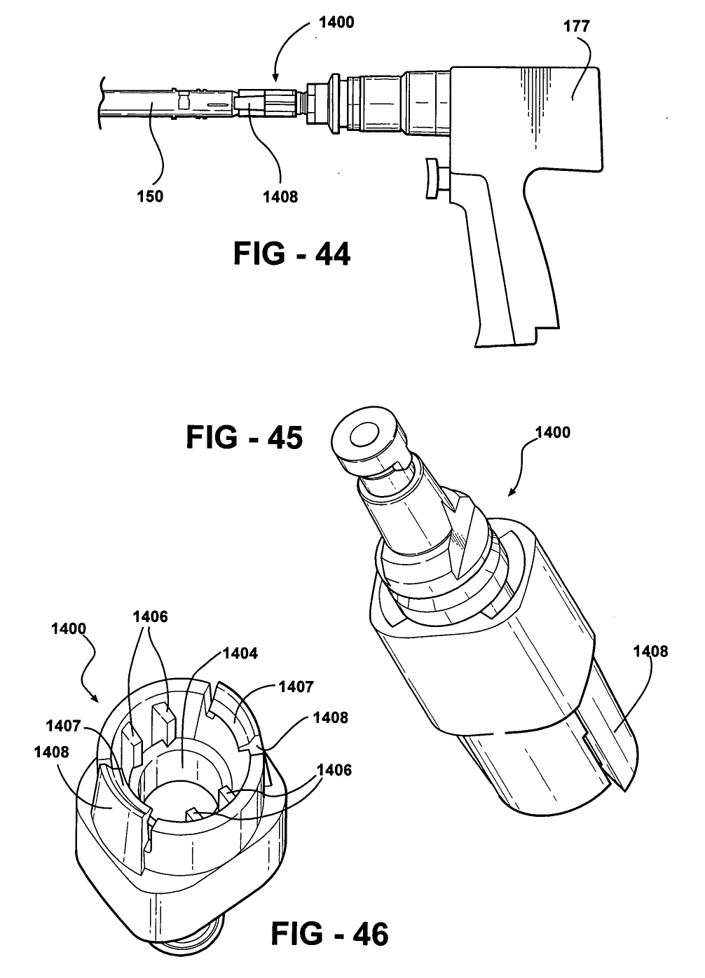

Referring to FIG. 43, the rotary power tool 177 and the mixing handle 177a of the bone cement mixing system can be selectively, interchangeably, and operatively connected to the proximal end 176 of the mixing shaft 150 in STEP 5 to mix the liquid and powder components of the bone cement in STEP 6. This provides the user with the flexibility of selecting the actuator that best suits their particular mixing needs. An adapter 1400 could be used to interconnect the rotary power tool 177 and the proximal end 176 of the mixing shaft 150. FIG. 44 shows this configuration. Here, the connection between the adapter 1400 and the rotary power tool 177 is a quick-connect type, which is well known in the power tool arts and will not be described in detail. Other connections, such as Jacob chuck connection or the like could also be used. It should be appreciated that the connection employed prevents relative axial and rotational motion between the adapter 1400 and the rotary power tool 177.

The adapter 1400, best shown in FIGS. 45 and 46, is connected to the proximal end 176 of the mixing shaft 150 via a snap-lock connection. Referring briefly back to FIG. 43, the proximal end 176 of the mixing shaft 150 includes a pair of flats 1402 that are received within a bore 1404 of the adapter 1400 along ribs 1406. The ribs 1406 are disposed in proximity to the flats 1402 to prevent relative rotation between the adapter 1400 and the mixing shaft 150. The adapter 1400 further includes a pair of snap-locking tabs 1408 that snap-lock to the mixing shaft 150 about an annular flange 1410 of the mixing shaft 150. This locks the adapter 1400 to the mixing shaft 150 and prevents relative axial motion between the adapter 1400 and the mixing shaft 150. Once snap-locked in place, a lip 1407 of each snap-locking tab 1408 rests within a groove 1409 defined about the mixing shaft 150 below the annular flange 1410 to axially restrain the adapter 1400. The ribs 1406 also abut the annular flange 1410 to axially restrain the adapter 1400 in the opposite direction. It should be appreciated that a proximal end of the adapter 1400 has a like configuration to the proximal end 176 of the mixing shaft 150. In fact, multiple adapters 1400 could be snap-locked together in the same fashion as snap-locking the adapter 1400 to the mixing shaft 150.

In practice, the adapter 1400 is preferably connected to the rotary power tool 177 initially and then snap-locked to the mixing shaft 150. This simplifies the connection between the rotary power tool 177 and the mixing shaft 150 for the user. In a typical connection between a power tool (such as a reamer drill) and its bit, a collar must be moved axially to lock the power tool and bit. By already having the adapter 1400 locked to the rotary power tool 177, the user only need make the simple snap-lock connection between the adapter 1400 and the mixing shaft 150 to mix the bone cement.

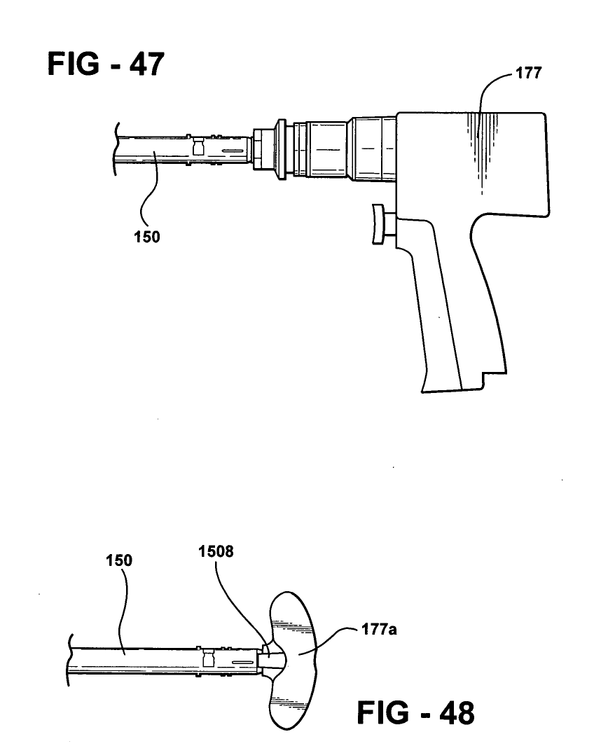

In FIG. 47, the connection is a quick-connect type, with the rotary power tool 177 being directly connected to the proximal end 176 of the mixing shaft 150. As previously discussed, this type of connection for power tools is well known to those skilled in the power tool arts. The connection employed prevents relative axial and rotational motion between the mixing shaft 150 and the rotary power tool 177. It should be appreciated that the rotary power tool 177 could also be configured in the same manner as the adapter 1400 to lock to the proximal end 176 of the mixing shaft 150.

Lastly, in FIG. 48, the mixing handle 177a is shown directly connected to the proximal end 176 of the mixing shaft 150. In this arrangement, the mixing handle 177a is locked to the mixing shaft 150 in precisely the same manner as the adapter 1400 is locked to the mixing shaft 150. In other words, the mixing handle 177a includes the same features as the adapter 1400 to snap-lock to the proximal end 176 of the mixing shaft 150. The mixing handle 177a includes a bore (see the bore 1404 of the adapter 1400) for receiving the flats 1402 on the proximal end 176 of the mixing shaft 150 along ribs (see the ribs 1406 of the adapter 1400) and a pair of snap-locking tabs 1508 that snap-lock to the mixing shaft 150 about the annular flange 1410 of the mixing shaft 150 to lock the mixing handle 177a to the mixing shaft 150 and prevent relative axial motion between the mixing handle 177a and the mixing shaft 150. In alternative embodiments, the adapter 1400 could also be used to interconnect the mixing handle 177a and the mixing shaft 150.

It should be appreciated that, in other embodiments, the plurality of actuators, i.e., the rotary power tool 177 or the mixing handle 177a, could also be fixed directly to the mixing shaft 150 by any conventional fastening technique such as using clamps, set screws, press-fits, and the like.

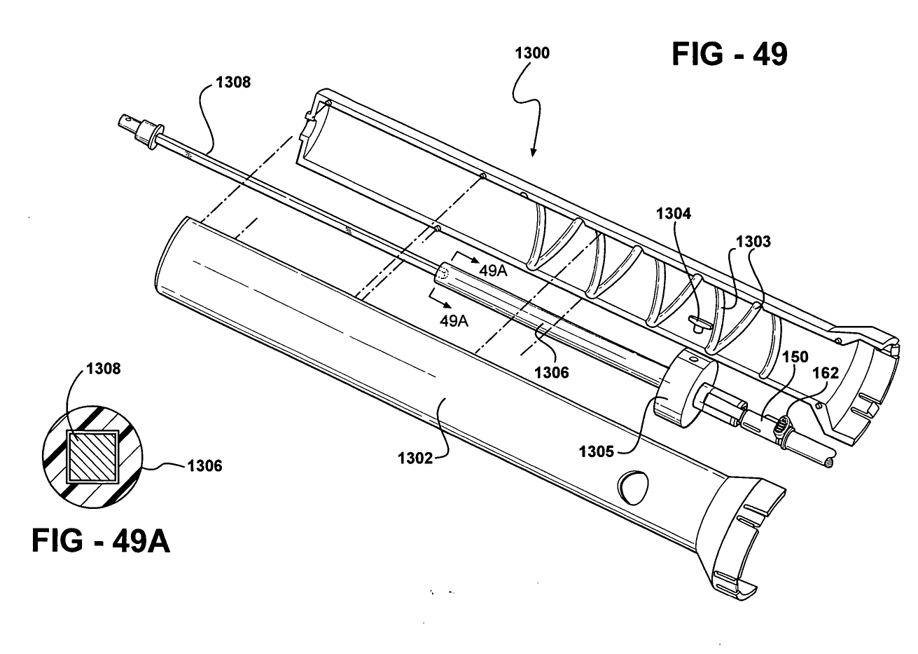

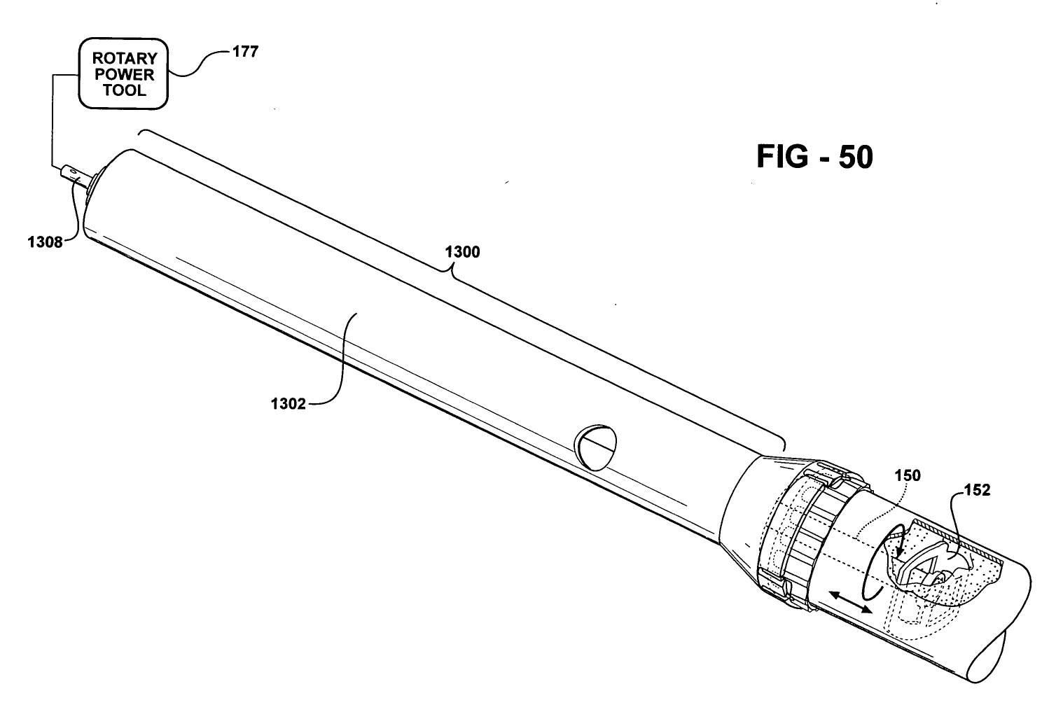

Referring to FIGS. 49, 49A, and 50, a converter 1300 can be used in combination with the rotary power tool 177 to mechanically convert rotational input provided by the rotary power tool 177 into both axial and rotational output to mix the liquid and powder components of the bone cement during mixing STEP 6 of FIG. 38. In previous embodiments, the user provides axial motion in the mixing chamber 108 by physically moving the mixing handle 177a or rotary power tool 177 axially. Here, the converter 1300 reduces the energy exerted by the user and subsequent fatigue. The converter 1300 can be integral with the cap 112 of the mixing cartridge 100, or the converter 1300 can be a separate component that locks onto the cap 112, as shown in FIG. 50.

The converter 1300 includes a cam housing 1302 and an input shaft 1308 rotatably supported and journaled in the cam housing 1302. The rotary power tool 177 is adapted to connect to the input shaft 1308 to rotate the input shaft 1308 relative to the cam housing 1302. An output shaft 1306 is coupled to the input shaft 1308. More specifically, the input shaft 1308 and the output shaft 1306 matingly engage one another to rotate together, as shown in FIG. 49A. The input shaft 1308 drives the output shaft 1306 via torque exerted on the input shaft 1308 by the rotary power tool 177. A collar 1305 is fixed to the output shaft 1306 and a follower 1304 is rotatably coupled to the collar 1305. A groove 1303 having helically-shaped crossing paths is formed on an inner surface of the cam housing 1302. The follower 1304 follows along the groove 1303 as the output shaft 1306 rotates with the input shaft 1308. This results in axial movement of the output shaft 1306 and collar 1305 relative to the input shaft 1308 and cam housing 1302. The follower 1304 follows along one helical path of the groove 1303 when moving distally and then transfers over to the other helical path of the groove 1303 to move proximally.

In operation, as the input shaft 1308 is driven, the output shaft 1306 rotates therewith while sliding along the input shaft 1308 in response to the follower 1304 following along the groove 1303. This action converts the rotational motion of the input shaft 1308 into rotational and axial motion of the output shaft 1306. The mixing shaft 150 is operatively connected to the output shaft 1306 to mix the bone cement. The mixing shaft 150 can be connected to the output shaft 1306 in any conventional manner known to those skilled in the art. In the embodiment shown in FIGS. 49 and 50, the output shaft 1306 is snap-locked to the mixing shaft 150 in a similar fashion as the adapter 1400.

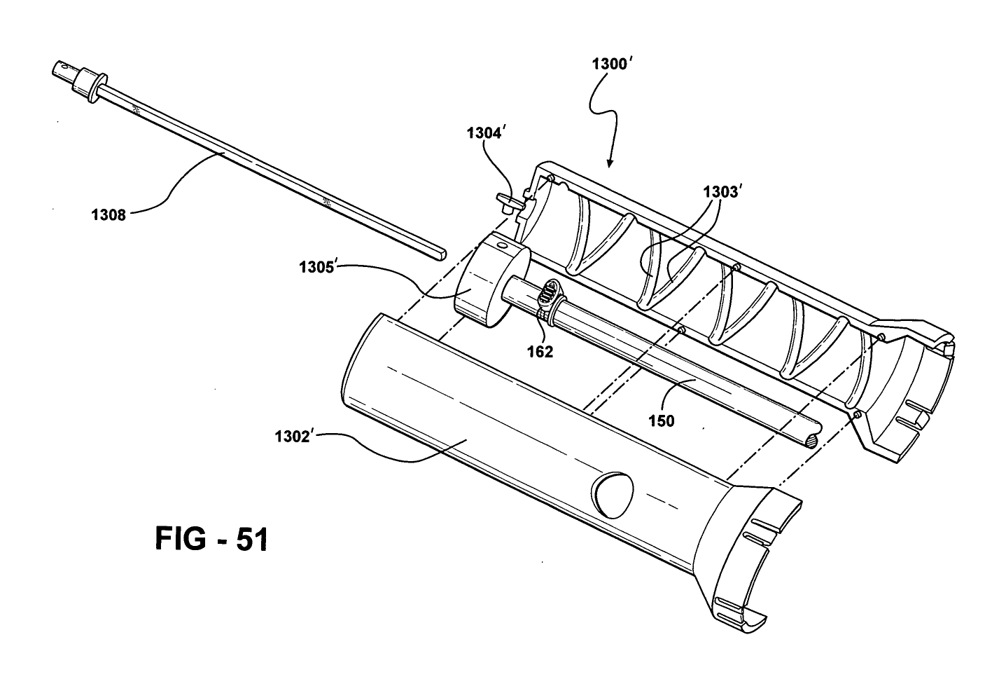

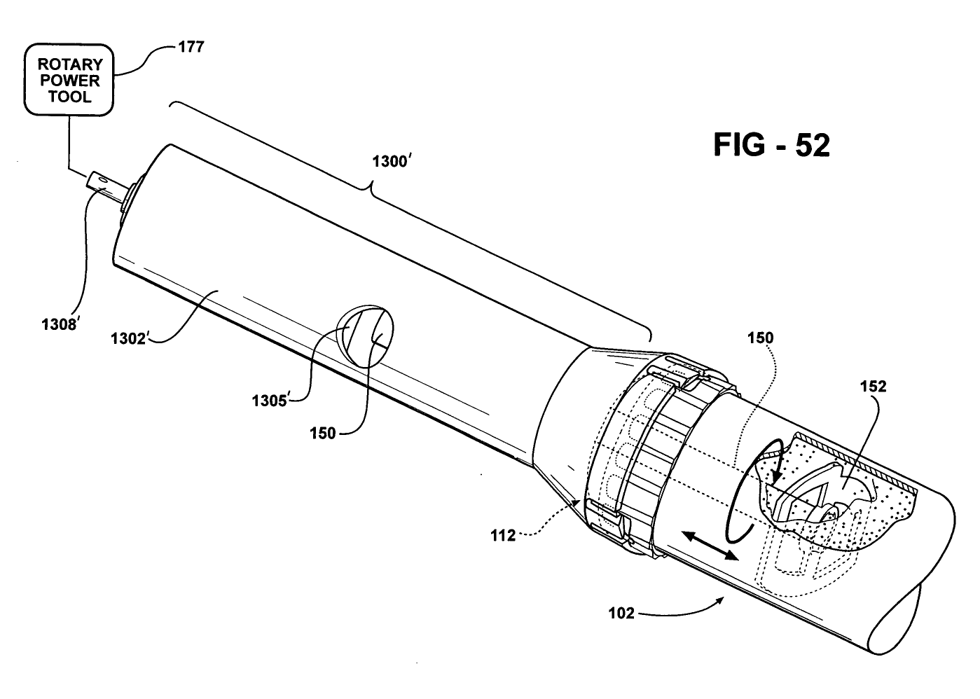

Prior to mixing, the converter 1300 would first be snap-fit to the cap 112, as shown in FIG. 50, with the output shaft 1306 telescoping distally to lock to the proximal end 176 of the mixing shaft 150. Once mixing is complete, the release button 162 would be actuated through a window formed in the cam housing 1302 to release the blade 152, and the converter 1300 would be removed from the cap 112. Alternatively, the mixing shaft 150 could be severed with the broken portion of the mixing shaft 150 and blade 152 remaining in the mixing chamber 108 after mixing. In the embodiment 1300′ shown in FIGS. 51 and 52, the output shaft is the mixing shaft 150, while the remaining features operate in the same manner as the previous embodiment of FIGS. 49 and 50.

It will be appreciated that the above description relates to the disclosed embodiments by way of example only. Many apparent variations of the disclosed invention will be known to those of skill in this area and are considered to be within the scope of this invention and are considered to be within the scope of the following claims. Obviously, many modifications and variations of the present invention are possible in light of the above teachings.

1. A bone cement loading system for receiving liquid and powder components of bone cement to be mixed for medical use, comprising:
a cylinder having an open proximal end and a closed distal end with a mixing chamber defined between said ends;
a base releasably coupled to said closed distal end of said cylinder for supporting said cylinder while loading the liquid and powder components therein;
a funnel releasably coupled to said open proximal end of said cylinder for channeling the components of the bone cement into said mixing chamber; and
packaging enclosing said cylinder, base, and funnel in a ready-to-use state such that said cylinder, base, and funnel can be transported in said ready-to-use state.

2. A bone cement loading system as set forth in claim 1 wherein said packaging comprises a tray and a cover with said cylinder, base, and funnel lying in said tray and said cover placed over said tray to enclose said cylinder, base, and funnel in said tray.

3. A bone cement loading system as set forth in claim 1 wherein said base defines a cavity and said closed distal end of said cylinder is releasably secured in said cavity.

4. A bone cement loading system as set forth in claim 1 wherein said funnel has a distal end with a circular periphery releasably press fit into said open proximal end of said cylinder and a proximal end with an oblong oval-shaped periphery to facilitate the transfer of the components of the bone cement into said mixing chamber.

5. A bone cement loading system as set forth in claim 1 including a piston locked in said cylinder to define said closed distal end.

6. A bone cement loading system as set forth in claim 3 wherein said base is oblong in shape and said cavity is circular in shape.

7. A bone cement loading system as set forth in claim 1 wherein one of said base and said cylinder includes a plurality of detents and the other of said base and said cylinder defines a groove in a surface thereof releasably receiving said detents to facilitate a snug fit between said base and said cylinder.

8. A method of loading liquid and powder components of bone cement to be mixed for medical use with a bone cement loading system comprising a cylinder having an open proximal end and a closed distal end with a mixing chamber defined between the ends, a base for coupling to the closed distal end of the cylinder, a funnel for coupling to the open proximal end of the cylinder, and packaging for enclosing the cylinder, base, and funnel, said method comprising the steps of:
coupling the base and funnel to the cylinder to present a bone cement loading assembly in a ready-to-use state;
enclosing the bone cement loading assembly in the packaging in the ready-to-use state;
transporting the bone cement loading assembly in the ready-to-use state after enclosing the bone cement loading assembly in the packaging;
removing the bone cement loading assembly from the packaging; and
loading the powder component of the bone cement into the mixing chamber through the funnel once the bone cement loading assembly is removed from the packaging.

9. A method as set forth in claim 8 including releasing the funnel from the cylinder after loading the powder component of the bone cement into the mixing chamber

10. A method as set forth in claim 9 including loading the liquid component of the bone cement into the mixing chamber once the funnel is released.

11. A bone cement mixing system for mixing liquid and powder components of bone cement for medical use, comprising:
a cartridge having proximal and distal ends with a mixing chamber defined between said ends;
a mixing device supported by said cartridge to mix the liquid and powder components of the bone cement; and
a plurality of actuators for selectively, interchangeably, and operatively connecting to said mixing device to actuate said mixing device and mix the liquid and powder components of the bone cement.

12. A bone cement mixing system as set forth in claim 11 wherein one of said plurality of actuators is a power tool and the other of said plurality of actuators is a manual mixing handle whereby a user can selectively, interchangeably, and operatively connect said power tool and said mixing handle to said mixing device.

13. A bone cement mixing system as set forth in claim 12 wherein said mixing device comprises a mixing shaft having a proximal end extending outside of said mixing chamber and a blade coupled to said mixing shaft and disposed in said mixing chamber to mix the liquid and powder components of the bone cement.

14. A bone cement mixing system as set forth in claim 13 wherein said proximal end of said mixing shaft includes a pair of flats and said mixing handle includes a plurality of ribs for engaging said flats to prevent relative rotation between said mixing shaft and said mixing handle.

15. A bone cement mixing system as set forth in claim 14 wherein said proximal end of said mixing shaft includes an annular flange and said mixing handle includes at least one locking tab for snap-lock engaging said annular flange to prevent relative axial motion between said mixing shaft and said mixing handle.

16. A bone cement mixing system as set forth in claim 13 including an adapter connected to said power tool wherein said proximal end of said mixing shaft includes a pair of flats and said adapter includes a plurality of ribs for engaging said flats to prevent relative rotation between said mixing shaft and said adapter.

17. A bone cement mixing system as set forth in claim 16 wherein said proximal end of said mixing shaft includes an annular flange and said adapter includes at least one locking tab for snap-lock engaging said annular flange to prevent relative axial motion between said mixing shaft and said power tool.

18. A bone cement mixing system as set forth in claim 13 wherein said proximal end of said mixing shaft includes a pair of flats and said power tool is adapted to engage said flats to prevent relative rotation between said mixing shaft and said power tool.

19. A bone cement mixing system as set forth in claim 18 wherein said power tool is adapted to engage said proximal end of said mixing shaft to prevent relative axial motion between said mixing shaft and said power tool.

20. A bone cement mixing system for use with a plurality of actuators to mix liquid and powder components of bone cement for medical use, comprising:
a cartridge having proximal and distal ends with a mixing chamber defined between said ends;
a mixing device supported by said cartridge to mix the liquid and powder components of the bone cement; and
said mixing device having a proximal end adapted for operatively connecting with each of the plurality of actuators to selectively, interchangeably, and operatively connect each of the plurality of actuators to said mixing device to mix the liquid and powder components of the bone cement.

21. A bone cement mixing system as set forth in claim 20 wherein said mixing device comprises a mixing shaft with said proximal end extending outside of said mixing chamber and a blade coupled to said mixing shaft and disposed in said mixing chamber to mix the liquid and powder components of the bone cement.

22. A bone cement mixing system as set forth in claim 21 wherein said proximal end of said mixing shaft includes an annular flange for operatively connecting with each of the plurality of actuators and preventing relative axial motion between said mixing shaft and each of the plurality of actuators and a pair of flats for preventing relative rotation between said mixing shaft and each of the plurality of actuators.

23. A bone cement mixing system for mixing liquid and powder components of bone cement for medical use, comprising:
a cartridge having proximal and distal ends with a mixing chamber defined between said ends;
a mixing device supported by said cartridge to mix the liquid and powder components of the bone cement;
a power tool for operatively connecting to said mixing device to mix the liquid and powder components of the bone cement in said mixing chamber; and
an adapter separable from and independent of said power tool for operatively connecting said power tool to said mixing device.

24. A bone cement mixing system as set forth in claim 23 wherein said mixing device comprises a mixing shaft having a proximal end extending outside of said mixing chamber and a blade coupled to said mixing shaft and disposed in said mixing chamber to mix the liquid and powder components of the bone cement.

25. A bone cement mixing system as set forth in claim 23 wherein said adapter includes at least one locking tab for snap-lock engaging said proximal end of said mixing shaft.

26. A bone cement mixing system as set forth in claim 23 wherein said proximal end includes an annular flange and said adapter includes a pair of locking tabs for snap-lock engaging said annular flange.

27. A bone cement mixing system as set forth in claim 26 wherein said proximal end includes a pair of flats and said adapter includes a plurality of ribs for engaging said flats to prevent relative rotation between said adapter and said mixing shaft.

28. A bone cement mixing system as set forth in claim 24 wherein said power tool is coupled to said adapter and said adapter is snap-lock engaged to said proximal end of said mixing shaft.

29. A bone cement mixing system for mixing liquid and powder components of bone cement for medical use, comprising:
a cartridge having proximal and distal ends with a mixing chamber defined between said ends;
a mixing device supported by said cartridge to mix the liquid and powder components of the bone cement;
a power tool for operatively connecting with said mixing device and providing rotational input; and
a converter for converting said rotational input from said power tool into axial and rotational output and applying said axial and rotational output to said mixing device to completely mix the liquid and powder components of the bone cement in said mixing chamber.

30. A bone cement mixing system as set forth in claim 29 wherein said converter comprises an input shaft and a housing for rotatably supporting said input shaft with said power tool being adapted for connecting to said input shaft to rotate said input shaft relative to said housing.

31. A bone cement mixing system as set forth 30 wherein said converter further comprises an output shaft operatively connected to said input shaft to rotate with said input shaft and move axially relative to said input shaft during rotation.

32. A bone cement mixing system as set forth in claim 31 including a collar fixed to said output shaft and a follower rotatably coupled to said collar.

33. A bone cement mixing system as set forth in claim 32 wherein said housing defines at least one helically-shaped groove on an inner surface thereof and said follower follows along said at least one helically-shaped groove to move said output shaft axially relative to said input shaft and said housing thereby converting said rotational input from said input shaft into axial and rotational output.

34. A bone cement mixing system as set forth in claim 33 wherein said output shaft is operatively connected to said mixing device to completely mix the liquid and powder components of the bone cement in said mixing chamber.

35. A method of mixing liquid and powder components of bone cement in a mixing chamber of a mixing cartridge using a power tool and a mixing device, said method comprising the steps of:
operatively connecting the power tool to the mixing device;
actuating the power tool after the power tool is operatively connected to the mixing device to provide rotational input to mix the liquid and powder components of the bone cement in the mixing chamber;
converting the rotational input from the power tool into axial and rotational output during actuation; and
applying the axial and rotational output to the mixing device during actuation to completely mix the liquid and powder components of the bone cement in the mixing chamber.

36. A delivery gun for receiving a mixing cartridge containing bone cement to deliver the bone cement to an anatomical site by discharging the bone cement from the mixing cartridge, said delivery gun comprising:
a casing;
a drive rod supported by said casing and including a plurality of teeth along a length thereof;
at least one pawl member engaging said plurality of teeth to advance said drive rod; and
a trigger pivotally supported by said casing and operatively connected to said at least one pawl member to advance said drive rod during actuation of said trigger with said at least one pawl member exerting a force upon said drive rod having a force vector with an X component that is from 1 to 6 times larger than a Y component of said force vector wherein said X component of said force vector is parallel to said drive rod and said Y component of said force vector is transverse to said drive rod.

37. A delivery gun as set forth in claim 36 wherein said X component of said force vector is from 2 to 3 times larger than said Y component of said force vector.

38. A delivery gun as set forth in claim 36 including a linkage system operatively interconnecting said trigger with said at least one pawl member, said linkage system comprising a first link pivotally connected to said casing and a second link interconnecting said first link and said trigger wherein said second link is pivotally connected to both said first link and said trigger such that actuating said trigger moves said second link and said first link to actuate said at least one pawl member and advance said drive rod to discharge the bone cement from the mixing cartridge.

39. A delivery gun as set forth in claim 36 including a biasing device for biasing said at least one pawl member into engagement with said teeth on said drive rod.

40. A delivery gun as set forth in claim 36 including a non-return pawl member pivotally supported by said casing about a pivot axis for preventing retraction of said drive rod relative to said casing wherein said non-return pawl member extends from said pivot axis to an engaging end engaging said plurality of teeth.

41. A delivery gun as set forth in claim 40 including a reference line extending between said pivot axis and said engaging end of said non-return pawl member wherein said reference line lies at an acute angle to said drive rod and said acute angle is from 0 to 45 degrees.

42. A delivery gun as set forth in claim 41 wherein each of said pawl members are curved along their lengths.
